(19) United States
(12) Patent Application Publication
(10) Pub. No.: US 2018/0141817 A1
(43) Pub. Date: May 24, 2018

(54) DISPERSING ADDITIVE

(71) Applicant: Technische Hochschule Nuernberg Georg Simon Ohm, Nuernberg (DE)

(72) Inventors: Gerd WEHNERT, Schnaittach (DE); Katharina STECKLEIN, Nuernberg (DE); Jens HELBIG, Nuernberg (DE); Herbert SCHLACHTER, Nuernberg (DE)

(21) Appl. No.: 15/552,664

(22) PCT Filed: Feb. 23, 2016
(86) PCT No.: PCT/EP2016/053790

§ 371 Date: Dec. 27, 2017

(30) Foreign Application Priority Data
Feb. 23, 2015 (DE) 10 2015 102 553.1

(51) Int. Cl. C01B 32/174; C09K 5/14; C08F 8/30; C08J 3/05; C08K 3/04; H01B 1/24

(52) U.S. Cl. CPC C01B 32/174; C09K 5/14; C08F 8/30; C08J 3/05; C08K 3/041; B82Y 30/00; C08J 2325/06; C08K 2201/001; C08K 2201/011; C01P 2006/32; C01P 2006/40; H01B 1/24

(57) ABSTRACT

The invention relates to a carbon nanomaterial dispersion in a dispersion medium, said dispersion medium containing an electron-deficient compound. The invention further relates to a use of an electron-deficient compound in a dispersion medium for modifying the dispersion behavior of carbon nanomaterial in the dispersion medium. The invention finally relates to a method for producing a polymer-containing material. According to said method, the dispersion is mixed with a polymer.

### FIELD OF THE INVENTION

The invention relates to a dispersion of a carbon nanomaterial in a dispersion medium. It further relates to a use of an electron-deficient compound in a dispersion medium.

### BACKGROUND OF THE INVENTION

The mechanical properties of carbon nanotubes (CNTs) are excellent. CNTs with a density of 1.3 to 1.4 g/cm³ have an excellent ultimate tensile strength of several megapascals. By comparison, steel at a density of at least 7.8 g/cm³ has a maximum ultimate tensile strength of only approximately 2 MPa, whereby it is calculated that for individual CNTs there is an at least 135-times better ratio of ultimate tensile strength to density than for steel. The following are of particular interest in the field of electronics: current carrying capacity (CCC) and electrical and thermal conductivity. The current carrying capacity is estimated to be 1000 times higher than in copper wires, whereas the thermal conductivity at room temperature is almost twice as high as that of diamond. Due to the mechanical and electrical properties thereof, carbon nanotubes can also be used in plastics as additives for polymers. In this way, for example, the mechanical properties of the plastics are greatly improved. In addition it is possible in this way to produce electrically conductive plastics. The improvement of the properties is realised already at low weight proportions, whereby such a composite material is very highly suited for lightweight construction.

A great problem for the effective use of such nanoparticles in polymers can be the dispersibility thereof, as they strongly attract each other through van der Waals forces and, based on their production, they usually become greatly entangled in each other and are present in agglomerate form. In order to be able to make full use of the advantages of the properties of carbon nanotubes, the latter should be present in the composite as far as possible as isolated tubes. This is difficult in principle because the strong van der Waals forces between the carbon nanotubes must be overcome for this. Even if the CNTs can be separated, they tend to re-agglomerate. Known methods can have the disadvantage that a homogeneous distribution of the CNTs in the polymer cannot be achieved, as the uniform dispersion of the carbon nanotubes in molten polymers is insufficient. CNTs can only be converted into stable dispersions with very great difficulty, in particular because the carbon nanotubes (CNTs) have a very high aspect ratio and are usually present in a highly agglomerated and/or entangled form. As a result, there has been no shortage of experiments in the prior art aimed at ensuring the stable dispersion of CNTs. The methods known from the prior art are, however, poorly suited for producing stable and concentrated dispersions of CNTs. Indeed, the methods of the prior art do not lead in most cases to storage-stable dispersions, and, in addition, the concentration of CNTs in the dispersions of the prior art is only extremely low in most cases.

Besides the purely mechanical approaches to dispersion, there is additionally the possibility of functionalising CNTs in order to improve interactions. This is realised either directly through chemical, covalent functionalisation of the CNTs or through the addition of dispersing additives, which act as a compatibilizers. Furthermore there are also a few special dispersion methods such as in situ polymerisation, wherein the CNTs are firstly dispersed in the monomer and then the polymerisation of the monomer components is realised, or solvent casting, wherein the polymer is dissolved and mixed with the CNTs. The possible disadvantages of the dispersion strategies are listed below:

Purely Mechanical Dispersion
No complete separation and homogenisation.
Poor long-term stability, due to re-agglomeration of the CNTs.
The structure of the CNTs is damaged under harsh dispersion conditions, whereby particular properties of the material are partially lost.

Mechanical Dispersion and Covalent Functionalisation
The structure of the CNTs (sp² hybridisation) is damaged during chemical functionalisation, whereby particular properties (electrical conductivity, mechanical stability) of the material are partially lost.
The covalent modification must be elaborately adapted to each polymer. This is difficult to implement on an industrial scale and is associated with high costs.

Mechanical Dispersion with Dispersing Additives
Interactions between CNTs and additives are not very well-developed (in most cases being no greater than the interactions between the CNTs themselves).
Low efficiency, in particular at higher CNT concentrations.
Ionic dispersing additives (e.g.: (poly) styrenesulfonate) PSS, cetyl pyridium chloride (CPC)) can be used for dispersion of CNTs in water, but are unsuitable for use in polymers.

Further dispersion methods
In situ polymerisation can only be used with special monomer components. Interference with the polymerisation reaction can arise.
In solvent casting (see, e.g., US 2004/0131859A1 and WO 02/076888A1), only soluble polymers can be used.
In both cases, the solvent must be separated in an additional method step.
Both methods facilitate the dispersibility by reducing the viscosity. The re-agglomeration tendency is not suppressed.

The previously described methods of the prior art result in most cases in inhomogeneous, often not long-term-stable dispersions of carbon nanotubes with low concentrations or contents of CNTs. Furthermore the dispersions of the prior art typically exhibit—in comparison with pure dispersion agents or dispersion media—a great, or even extreme, increase in viscosity at the same time as only low particle contents of carbon nanotubes of generally only up to approximately 1 wt.%.

The following Table 1 provides a short overview of the dispersion methods and production methods of CNT polymer composites:

TABLE 1
Dispersion methods and production
methods for CNT polymer composites

| | | Reactive | |
|---|---|---|---|
| Type | Solvent-based | pre-polymer | Polymer melt |
| Variants | Pure solvent as pre- | Reaction resin | Melt mixing |
| | stage | | |
| | Dissolved polymer | | |
| | (solvent casting) | | |
| | Dispersion in | | |
| | monomer, then | | |
| | polymerisation (in- | | |
| | situ polymerisation) | | |
| Dispersion | Ultrasound | Three-roll mill (can | Extruder |
| method | Ball mill | also be used with | Injection |
| | Micro-fluidiser | very high viscosity) | moulding |
| | | (Ball Mill) | equipment |
| | | (Disperser) | |
| Advan- | Viscosity can be | Solvent is not | Direct tests and |
| tages | adjusted | absolutely | most cost- |
| | | necessary | efficient method |
| | | | in order to |
| | | | produce a CNT |
| | | | compound |
| | | | Universally |
| | | | applicable to all |
| | | | polymers |
| Disadvan- | Solvent must be | Limited to reactive | Agglomerates |
| tages | removed | polymer pre-stages | are poorly |
| | Solvent casting and | Difficult processing | broken up |
| | in-situ | when the filler | CNTs must be |
| | polymerisation can | contents are high, | pre-treated |
| | only be used on | due to the high | |
| | suitable polymers | viscosity | |
| Possible | Addition in the | Direct addition in | Addition after |
| provision | dispersion step | the dispersion step | pre-dispersion in |
| of additive | In the case of in-situ | or addition after pre- | solvent |
| | polymerisation, | dispersion in solvent | |
| | possible interference | | |
| | with the | | |
| | polymerisation | | |
| | reaction | | |

Dispersion media that contain pyrene are known in themselves and have already been used by Lou et. al., Chem. Mater, 4005-4011, 2004 and also by Bahun et. al., J. Polym. Sci. Part A: Polym. Chem. 44 1941-1951, 2006 as additives in organic solvents for the dispersion of carbon nanotubes. However, these dispersion media were only limitedly effective in the organic solvents and merely a low degree of solubility (i.e. finely dispersed solution) of the CNT of up to a maximum of 0.65 mg/mL was achieved in THF.

A similarly poor dispersion effect occurred in EP 1965451 A1 with dispersion media consisting of an aromatic head, which forms the main chain, and an aliphatic tail, which forms the side chain.

DE102009013418 A1 discloses a method for dispersion of nanoparticles, in particular carbon nanotubes, in a medium-viscosity fluid medium, wherein the nanoparticles and the fluid medium together go through a number m of passages of one or more multi-screw extruders with one or more kneading zones, wherein m is an integer and is greater than or equal to 1.

DE 102009012675 A1 describes a method for the dispersion of graphite-type nanoparticles, wherein the graphite-type nanoparticles are dispersed in a continuous liquid phase with energy input in the presence of the dispersion medium. The dispersion media consist of block copolymers, of which at least one block carries an aromatic group, which is/are bonded via aliphatic chain members to the main chain of the block copolymer.

DE 102009012674 A1 discloses semi-crystalline polyurethane (PUR) compounds filled with carbon nanotubes, these compounds being obtained on the basis of water-based polyurethane-CNT mixtures. Furthermore a method is disclosed for the production of the polyurethane compounds, wherein water-based polyurethane lattices are mixed with carbon nanotubes, which are dispersed in water. The invention further relates to films that are produced through pressure injection moulding processes or treating processes for casting solutions.

DE 102006055106 A1 describes a method for dispersing carbon nanotubes in a continuous phase, in particular in at least one dispersion medium, wherein the carbon nanotubes are dispersed in a continuous phase, in particular in at least one dispersion medium, in the presence of at least one dispersion medium with the incorporation of an energy input sufficient for the dispersion.

DE 10301996 A1 discloses a method for producing carbon nanotube-reinforced polymers, having the method steps: synthesising the polymer by means of polycondensation reaction, and adding carbon nanotubes.

WO 2013073259 A1 discloses a polystyrene sulfonic acid (salt), which is suited as a dispersion medium for the production of an aqueous dispersion of a carbon nanomaterial such as a carbon nanotube, graphene or fullerene or an aqueous dispersion of a conductive polymer, such as a polythiophene, polypyrrole, polyaniline, polyphenylene vinylene or polyphenylene sulphide.

WO 2012177975 A1 discloses a method for producing carbon nanotube films. In this case, carbon nanotubes (CNTs) react in the presence of a strong acid with compounds that have polyaromatic radicals.

### Object of the Invention

It is the object of the invention to provide an improved dispersion of a carbon nanomaterial in a dispersion medium. In particular, the following is to be achieved: namely the adaptation of the dispersion behaviour of the carbon nanomaterial in the dispersion to the respective technical requirements of the dispersion in each case, for example to diminish or improve them. It is furthermore an object of the invention to provide a new use of an electron-deficient compound in a dispersion medium. In particular, it is to be achieved as follows with the invention: through the use of the electron-deficient compound in the dispersion medium, to create dispersions with new, advantageous properties, for example advantageous mechanical, electrical, chemical or thermal properties.

### Solution According to the Invention

In one aspect of the invention the object is achieved by means of a dispersion of a carbon nanomaterial in a dispersion medium, wherein the dispersion medium contains an electron-deficient compound. The invention enables advantageous use to be made of the fact that electron-deficient compounds can interact with carbon nanomaterials. It can be achieved with the invention that the electron-deficient compound, through interaction with the carbon nanomaterials, changes the compatibility of the carbon nanomaterials with the dispersion medium, for example improving or diminishing it. In particular it can be achieved that, with the invention, the dispersion behaviour of the carbon materials in the dispersion medium can be influenced, for example being improved or diminished.

According to the sense of the present invention “carbon nanomaterial” is a heading, which includes the carbon nanomaterial types: carbon nanotubes, carbon nanofibers, carbon nanorollers, graphene and fullerene and their derivatives. A carbon nanomaterial can consist of one or a mixture of the aforementioned carbon nanomaterial types.

“Carbon nanotubes” (CNTs) are tubular structures made up of a network of sp² hybridised carbon atoms. The carbon atoms assume a honeycomb-like structure with hexagons and respectively three bonding partners (the structure being provided by the sp² hybridisation). A distinction is made in principle between single-walled carbon nanotubes (SWCNTs) and multi-walled carbon nanotubes (MWCNTs). While the SWCNTs consist of a single graphite layer joined together to a tube, the MWCNTs have at least two of these layers, which are arranged concentrically nested inside each other. Furthermore a distinction is made between armchair, zigzag and chiral nanotubes, wherein, for this distinction, the angle at which the graphite layers are joined together to form a tube is the relevant factor. Furthermore a distinction is made between open and closed carbon nanotubes, wherein the latter are closed at one or both ends with a ‘cap’ in the manner of a fullerene structure. Carbon nanotubes can be empty or filled.

“Carbon nanofibers” are cylindrical nanostructures that are similar to the CNTs. The individual graphene layers are stacked one on top of the other transversely relative to the length of the fibre. The graphene layers can be planar, angular, curved or in the form of cones.

“Carbon nanorollers” according to the sense of the present invention differ from multi-walled carbon nanotubes in that the tube walls are not closed, but instead are rolled up onto themselves in the manner of a spiral, and thereby have one or more edges of the carbon layer or carbon layers forming the wall, these edges extending in the length direction of the nanoroller. A single wall or a plurality of walls lying one on top of the other can be rolled up onto themselves. Carbon nanorollers, like carbon nanotubes, can be empty or filled.

“Graphene” in the sense of the present invention describes a modification of carbon, which, like the walls of the carbon nanotubes and carbon nanorollers, consists of a network of sp² hybridised carbon atoms, wherein the carbon atoms have a honeycomb-like structure with hexagons and respectively three bonding partners (the structure being provided by the sp² hybridisation). Unlike the carbon nanotubes, however, they are not joined together to form a tube, and unlike nanorollers, they are not rolled up onto themselves. A distinction is made between single-layered and multi-layered graphene, wherein a single-layered graphene consists of a single one-layered network of these sp² hybridised carbon atoms, whereas, in the case of a multi-layered graphene, a plurality, and indeed up to ten, of these layers are arranged one on top of the other in the manner of a graphite structure.

“Fullerenes” in the sense of the present invention are spherical molecules consisting of carbon atoms. The carbon atoms are joined together partially to form pentagons and partially to form hexagons, wherein the impossibility of completely covering a plane with regular pentagons or with a combination of regular pentagons and hexagons results in spherical concavity. The smallest fullerene is a dodecahedron, C₂₀, and consists only of pentagonal carbon rings. Another fullerene, C₆₀ is joined together from pentagons and hexagons in the manner of a football. Like carbon nanotubes, fullerenes can also be single-walled or multi-walled, and filled or empty.

“Electron-deficient compounds” in the sense of the present invention are chemical compounds that have electron-deficient bonds. Electron-deficient bonds are in turn chemical bonds, wherein certain atoms are positively polarised by neighbouring electron-attracting groups via inductive or mesomeric effects. The electron-deficient compounds typically include electron-attracting groups such as, for example, COOR, COOH, CHO, C═(O)R, CN, CH═CHCOOH, NO₂ ,═O or —NO.

A “dispersion” in the sense of the present invention is a heterogeneous mixture of the carbon nanomaterial and a dispersion medium, in which the carbon nanomaterial is dispersed. The dispersion according to the invention includes embodiments, in which the electron-deficient compound is the single component of the dispersion medium, and also embodiments, in which the dispersion medium includes further components, besides the electron-deficient compound. The dispersion medium can be liquid or also solid.

In a further aspect of the invention the object is achieved through the use of an electron-deficient compound in a dispersion medium for modifying the dispersion behaviour of carbon nanomaterials in the dispersion medium. “Modifying” means that the dispersion behaviour of the carbon nanomaterial depends on the presence of, or the type of, the electron-deficient compound. The use according to the invention includes embodiments, in which the electron-deficient compound is the single component of the dispersion medium, and also embodiments, in which the dispersion medium includes further components, besides the electron-deficient compound.

In a further aspect of the invention the object is achieved by means of a method for producing a polymer-containing substance, wherein the dispersion is mixed with a polymer.

The invention allows advantage to be taken of the fact that electron-deficient compounds that interact better with the carbon nanomaterial than the particles of the carbon nanomaterial interact between themselves can be prepared In this respect, the invention can be distinguished particularly advantageously from additive systems known from the prior art, wherein the interaction between the additive and the particles of the carbon nanomaterial and the interaction between the particles of the carbon nanomaterial are virtually identical. An advantage that can be achieved with the invention is to embed carbon nanomaterials, e.g. carbon nanotubes, permanently in a polymer matrix. The invention enables a polymer matrix to be mechanically reinforced.

### Preferred Embodiments of the Invention

Advantageous embodiments and refinements, which can be used alone or in combination with each other, are the subject matter of the dependent claims.

In one preferred embodiment of the invention the electron-deficient compound is the only electron-deficient compound in the dispersion medium. In an alternative embodiment of the invention, the dispersion medium includes, besides the electron-deficient compound, one or more further electron-deficient compounds.

In one preferred embodiment of the invention the electron-deficient compound is an electron-deficient aromatic compound. An “electron-deficient aromatic compound” in the sense of the present invention is an electron-deficient compound, which has at least one ring system, which, in accordance with Hückel's rule, in conjugated double bonds, contains a number of 4n+2 delocalised electrons, wherein n>=0, free electron pairs or unoccupied p orbitals. The electron-deficient aromatic compound is preferably an aromatic compound that is conjugated with one or more electron-attracting side groups, e.g. COOR, COOH, CHO, C═(O)R, CN , CH═CHCOOH, NO₂, —Oor NO. In this embodiment of the invention it is possible to take advantage of the fact that the electron-deficient aromatic compounds can exhibit particularly strong π-interactions with the carbon nanomaterial. An aromatic system, as also in the case of the carbon nanomaterial, forms π complexes with electron-deficient aromatic compounds. In π complexes the attracting force of the participating molecules is significantly greater than in a π interaction without electron-deficient aromatic compound. This phenomenon was first described by Fritzsche by reference to the example of the crystalline picrates (J. Fritzsche, “Ueber Verbindungen von Kohienwasserstoffen mit Pikrinsäure”, “Journal für praktische Chemie, pp 282-292, 1858). Suitable electron-deficient aromatic compounds are for example picrates. An achievable advantage of this embodiment of the invention is that, through the particularly strong coupling of the electron-deficient compound with the carbon nanomaterial, the latter can be functionalised in a permanent and stable way. In particular the dispersion behaviour of the carbon nanomaterial can advantageously be adapted, for example improved or diminished, with respect to the requirements in each case.

In a preferred embodiment of the invention the dispersion medium includes a polymer. A “polymer” in the sense of the present invention is a macromolecule, which is made up of one or more structural units, the so-called repeat units. As polymers are the main components of plastics, this embodiment of the invention facilitates the provision of dispersions of carbon nanomaterials in plastics. It is an achievable advantage of the invention that, through such a process of working carbon nanomaterials into plastics, plastics with new, advantageous properties, for example advantageous mechanical, electrical, chemical or thermal properties, can be provided. A suitable polymer is a thermoplastic, for example a polystyrene (PS), polyethylene (PE), polypropylene (PP), polyvinyl chloride (PVC), polyamide (PA), inter alia. A further suitable polymer is a duromer or an elastomer, e.g. a butadiene rubber, or a thermoplastic elastomer. In a preferred embodiment of the invention the dispersion contains a mixture of a plurality of polymers, for example several from the group of the aforementioned polymers, for example two, three or four polymers.

The preferred polymer is different from the electron-deficient compound, even if the electron-deficient compound itself, as described below, is a polymer. In the sense of the present invention polymers are “different” if they are made up of different repeat units, e.g. polystyrene is different from polyethylene. If the dispersion medium has, besides the electron-deficient compound, one or more further electron-deficient compounds, the preferred polymer is particularly preferably also different from the, or all of the, further electron-deficient compound(s). The electron-deficient compound can advantageously act as a compatibilizer between the carbon nanomaterial and the polymer. It can also be achieved that the further electron-deficient compound(s) act as compatibilizer(s) between the carbon nanomaterial and the polymer.

The dispersion medium can contain a solvent, in which the polymer, or, in the case of a dispersion medium with a plurality of polymers a plurality or all polymers, of the dispersion medium is/are dissolved. A preferred solvent is an organic solvent, for example petroleum ether, toluene, chloroform, dichloromethane, dichloroethylene, tetrachloroethylene, diethyl ether, acetic acid ethyl ester, acetone, ethanol. However, the invention also includes embodiments with inorganic solvents, for example water.

The dispersion medium is preferably liquid at the time of the dispersion of the carbon nanomaterial in the dispersion medium. Particularly preferably it solidifies at a time after the dispersion of the carbon nanomaterial, for example by removing the solvent, by cooling or through a chemical reaction in the dispersion medium.

In a preferred embodiment of the invention the electron-deficient compound is an electron-deficient polymer. An “electron-deficient polymer” in the sense of the present invention is a polymer, in which at least some of the repeat units are electron-deficient repeat units. “Electron-deficient repeat units” in the sense of the present invention are repeat units which would be defined, as monomers, as electron-deficient compounds in the sense of the aforementioned definition. Preferably more than two, particularly preferably more than a tenth, particularly preferably more than a quarter, particularly preferably more than half of the repeat units are electron-deficient repeat units. In this embodiment of the invention, full advantage can be taken of the fact that the interaction between the carbon nanomaterial and the electron-deficient polymer can be multiplied through a multitude of electron-deficient repeat units. It is an achievable advantage of this embodiment of the invention that, through a plurality of electron-deficient compounds in the electron-deficient polymer, a particularly stable functionalisation of the carbon nanomaterial is possible. In this way the interaction between the carbon nanomaterial and the dispersion medium can advantageously be improved. In particular it can be achieved that the dispersibility of the carbon nanomaterial in the dispersion medium is changed, for example being improved or diminished.

A preferred electron-deficient repeat unit in the electron-deficient polymer is an electron-deficient aromatic compound. If the electron-deficient polymer is a homopolymer, it can for example be a polynitrostyrene, a polydinitrostyrene or a polytrinitrostyrene.

A preferred electron-deficient polymer is a copolymer. A “copolymer” according to the sense of the present invention is a polymer that is composed of two or more different types of repeat units. At least a proportion of the repeat units of the polymer are electron-deficient repeat units. The copolymer can for example be a static copolymer or an alternating copolymer. The preferred electron-deficient repeat unit of the copolymer is an electron-deficient aromatic, for example dinitrostyrene or trinitrostyrene. The invention also includes embodiments, in which the copolymer has a plurality of different electron-deficient repeat units, for example from the aforementioned group of electron-deficient repeat units, as repeat units.

A preferred electron-deficient polymer is a block copolymer. The block copolymer includes at least two blocks of different repeat units. The repeat units of at least one of the blocks are electron-deficient repeat units. In one embodiment of the invention the electron-deficient polymer is a graft copolymer. In this case the repeat unit of at least the backbone or at least a part of the grafts is an electron-deficient repeat unit. It is an achievable advantage of the copolymer that it can be used in association with the carbon nanomaterial, preferably via π-interaction, as well as being used also in association with other polymer bonds, preferably secondary valence bonds.

The preferred dispersion has, besides the electron-deficient polymer, a further polymer, i.e. the further polymer is different from the electron-deficient polymer. The further polymer is for example one of the group of thermoplastics, for example a PS, PE, PP, PVC, PA, one of the group of thermosets, for example a phenol or epoxy resin, or from the group of elastomers, for example a butadiene rubber or a thermoplastic elastomer. In this embodiment of the invention the electron-deficient polymer can act as a compatibilizer between the carbon nanomaterial and the other polymer(s). In particular the dispersion behaviour of the carbon nanomaterial in the other polymer can be changed, for example being improved or diminished. The electron-deficient polymer has particularly preferably repeat units or, in the case of a block or graft copolymer, blocks or grafts, which form stronger secondary valence forces with the other polymer than the carbon nanomaterial.

In an alternative embodiment of the invention the electron-deficient polymer is the only polymer, i.e. the single polymer, in the dispersion medium, i.e. the carbon nanomaterial is dispersed in the electron-deficient polymer.

In a preferred embodiment of the invention the carbon nanomaterial contains carbon nanotubes. Particularly preferably it consists of carbon nanotubes.

Carbon nanotubes can have particularly favourable properties in relation to the mechanical loading capacity and the electrical and thermal conductivity. In addition, they can provide plastics with similar properties if they are added thereto as filler. However, due to strong van der Waals forces between the carbon nanotubes and incompatible interactions between the carbon nanotubes and the plastic matrix, carbon nanotubes tend to exhibit a marked formation of agglomerates. This can have an unfavourable effect on the practical use of the carbon nanotubes as fillers, for example because the agglomerates of the plastic are only incompletely wetted. In actual fact, the mechanical properties of the polymer can even diminish for this reason through the addition of carbon nanotubes. The electron-deficient compound according to the invention can counteract the bonding of agglomerates.

The preferred nanotubes have diameters in the range of from 1 to 50 nanometres.

In a preferred embodiment of the invention the electron-deficient compound is the single component of the dispersion medium, i.e. the dispersion consists merely of the carbon nanomaterial and the electron-deficient compound. Such a dispersion can also be described as a “master batch”. In another preferred embodiment the dispersion, which can be referred to as the master batch, contains in the dispersion medium, besides the electron-deficient compound, a further polymer differing from the electron-deficient compound.

In a preferred embodiment of the invention the carbon nanomaterial, preferably carbon nanotubes, before or during the dispersion of the carbon nanomaterial in the dispersion material according to the invention, is additionally dispersed by means of a mechanical process. Suitable mechanical processes are known to the person skilled in the art from the prior art. In the case of mechanical dispersion in the presence of the electron-deficient compound the dispersion can be realised with a smaller input of force and the stability of the dispersion significantly improved. The possible problem of separate particles of carbon nanomaterials, in particular carbon nanotubes, causing a great increase in the viscosity with already low weight proportions of the carbon nanomaterial, which can make the dispersion more difficult, can also be advantageously counteracted.

In one embodiment of the invention the mechanical dispersion takes place before the dispersion in the dispersion medium according to the invention, particularly preferably in a solvent, e.g. in one of the solvents mentioned further above. The solvent can advantageously ensure the component mobility that is required at a certain level in most dispersion methods. In the case of the mechanical dispersion method, agglomerates of the carbon nanomaterial can advantageously be broken up, which can be advantageous, e.g. for carbon nanotubes or graphene, which are usually present in an initially highly agglomerated form based on the production thereof.

In a preferred dispersion the particles of the carbon nanomaterial are homogeneously distributed. In this way—for example as in the case of a plastic as a dispersion medium—a particularly great mechanical reinforcement can be achieved.

In another preferred dispersion the carbon nanomaterial is non-homogeneously distributed in the dispersion medium. A non-homogeneous distribution of the carbon nanomaterial can have a positive effect on the electrical conductivity. Preferably the particles of the carbon nanomaterial, particularly preferably carbon nanotubes, are in direct contact with each other. In one preferred embodiment of the invention, two different electron-deficient compounds according to the invention are used. Particularly preferably one of the electron-deficient compounds separates the particles of the carbon nanomaterial, e.g. the carbon nanotubes, and with the other electron-deficient compound the particles of the carbon nanomaterial, e.g. the carbon nanotubes, are joined together at certain points. In a preferred method according to the invention a polymer is contained in the dispersion and this polymer is the same as the polymer, with which the dispersion is mixed. “The same” in the sense of the invention means “not different”. In a preferred method according to the invention, the polymer with which the dispersion is mixed is different from the electron-deficient compound of the dispersion.

### BRIEF DESCRIPTION OF THE DRAWINGS

The invention will be described in greater detail below by reference to schematic drawings, in which:

FIG. 1 shows the change in colour, i.e. the discolouration, of solutions of naphthalene (0.8 mol/L) and pyrene (1.3 mol/L) in chloroform under the effect of light after (1) 0 minutes, (2) 2 minutes, (3) 3 minutes, (4) 4 minutes, (5) 9 minutes, (6) 47 minutes; sequence of the solutions prepared from left to right: naphthalene solution in air, naphthalene solution in argon atmosphere, pyrene solution in air and pyrene solution in argon atmosphere;

FIG. 2 shows an experimental set-up for mononitration of polystyrene;

FIG. 3 shows a set-up for precipitation of the solution;

FIG. 4 shows a set-up for filtration of the precipitate;

FIG. 5 shows a polystyrene sample after single nitration and prior to dissolving in DMF: a) yellow flakes b) yellow clotted, i.e. lumpy, precipitate as a result of excessively rapid precipitation into 2-propanol;

FIG. 6 shows dried reaction product after the mononitration of the polystyrene;

FIG. 7 shows brown clotted precipitate that arises during nitration;

FIG. 8 shows dried reaction product after dinitration of the polystyrene in chloroform;

FIG. 9 shows brown-green clotted precipitate formed during the nitration in 1,2-dichloroethane;

FIG. 10 shows dried reaction product after dinitration in 1,2-dichloroethane;

FIG. 11 shows an experimental set-up for trinitration of polystyrene;

FIG. 12 shows a set-up for precipitation of the solution;

FIG. 13 shows dried reaction product after trinitration;

FIG. 14 shows a set-up for photographic documentation of the sedimentation behaviour;

FIG. 15 shows a detailed image of the set-up for photographic documentation of the sedimentation behaviour;

FIG. 16 shows a set-up for sonication;

FIG. 17 shows colour reaction of the acceptor solutions when naphthalene is added;

FIG. 18 shows crystal formation after formation of a complex of naphthalene with a) DDQ and b) TONE;

FIG. 19 shows the extinction spectrum of naphthalene, DDQ and complex DDQ-naphthalene in the wavelength range of from 500-800 nm;

FIG. 20 shows the extinction spectrum of pyrene, DDQ and complex DDQ-pyrene in the wavelength range of from 450-900 nm;

FIG. 21 shows the extinction spectrum of coronene, DDQ and complex DDQ-coronene in the wavelength range of from 700-900 nm;

FIG. 22 shows the extinction spectrum of naphthalene, TONE and complex TCNE-naphthalene in the wavelength range of from 350-600 nm;

FIG. 23 shows the extinction spectrum of pyrene, TONE and complex TONE-pyrene in the wavelength range of from 400-800 nm;

FIG. 24 shows the extinction spectrum of coronene, TONE, and complex TCNE-coronene in the wavelength range of from 500-900 nm;

FIG. 25 shows job plot of complex DDQ-naphthalene at 621 nm;

FIG. 26 shows job plot of complex DDQ-pyrene at 846 nm;

FIG. 27 shows job plot of complex DDQ-coronene at 833 nm;

FIG. 28 shows job plot of complex TONE-naphthalene at 430 nm;

FIG. 29 shows job plot of complex TONE-pyrene at 494 nm;

FIG. 30 shows a job plot of complex TONE-coronene at 725 nm;

FIG. 31 shows the extinction spectrum of complex DDQ-naphthalene in the case of variation of the naphthalene concentration and a constant DDQ concentration of 0.4 mmol/L;

FIG. 32 shows the extinction spectrum of complex DDQ-pyrene in the case of variation of the pyrene concentration and a constant DDQ concentration of 0.4 mmol/L;

FIG. 33 shows the extinction spectrum of complex DDQ-coronene in the case of variation of the DDQ concentration and a constant coronene concentration of 0.7 mmol/L;

FIG. 34 shows the extinction spectrum of complex TCNE-naphthalene in the case of variation of the naphthalene concentration and a constant TONE concentration of 2.5 mmol/L;

FIG. 35 shows the extinction spectrum of complex TCNE-pyrene in the case of variation of the pyrene concentration and a constant TONE concentration of 0.6 mmol/L;

FIG. 36 shows the extinction spectrum of complex TONE-coronene in the case of variation of the TONE concentration and a constant coronene concentration of 0.4 mmol/L;

FIG. 37 shows formation constants and extinction coefficients of different charge transfer complexes;

FIG. 38 shows the FT-IR spectrum of polystyrene (red) and mononitrated polystyrene (blue);

FIG. 39 shows the FT-IR spectrum of polystyrene (red) and polystyrene dinitrated in chloroform (lilac);

FIG. 40 shows the FT-IR spectrum of polystyrene (red) and polystyrene dinitrated in 1,2-dichloroethane (green);

FIG. 41 shows the FT-IR spectrum of polystyrene dinitrated in chloroform (red) and trinitrated (blue);

FIG. 42 shows the GPC measurement of the polystyrene used for mononitration;

FIG. 43: shows the GPC measurement of the mononitrated polystyrene;

FIG. 44 shows the GPC measurement of the polystyrene used for dinitration in 1,2-dichloroethane;

FIG. 45 shows the GPC measurement of the polystyrene dinitrated in 1,2-dichloroethane;

FIG. 46 shows the GPC measurement of the polystyrene used for dinitration in chloroform;

FIG. 47 shows the GPC measurement of the polystyrene dinitrated in chloroform;

FIG. 48 shows the GPC measurement of the trinitrated polystyrene;

FIG. 49 shows the thermogravimetric measurement of the polystyrene sample (black) and the reaction product of mononitration (green);

FIG. 50 shows the thermogravimetric measurement of the polystyrene sample (black) and the reaction product of dinitration in chloroform (blue);

FIG. 51 shows the thermogravimetric measurement of the polystyrene sample (black) and the reaction product of dinitration in 1,2-dichloroethane (blue);

FIG. 52 shows the thermogravimetric measurement of the reaction product of dinitration in chloroform (black) and the reaction product of trinitration (green);

FIG. 53 shows samples 1, 2 and 3 directly after sonication;

FIG. 54 shows samples 1, 2 and 3 after three days of storage;

FIG. 55 shows samples 4, 5, 6, 7 and 8 directly after sonication;

FIG. 56 shows samples 4, 5, 6, 7, and 8 directly after centrifugation;

FIG. 57 shows a comparison of the samples based on the masses of the CNTs that have settled;

FIG. 58 shows a comparison of the masses of CNTs that have been additionally dispersed in DMF by an additive;

FIG. 59 shows electron donors used;

FIG. 60 shows a REM image of the MWCNTs Nanocyl™ NC7000 with 500× magnification;

FIG. 61 shows a REM image of the MWCNTs Nanocyl™ NC7000 with 1000× magnification;

FIG. 62 shows electron acceptors used;

FIG. 63 shows structural formulae of polystyrene, poly-(4-mononitro-styrene), poly-(2,4-dinitro-styrene) and poly-(2, 4,6-trinitro-styrene);

FIG. 64 shows charts for calculating the formation constants and extinction coefficients of different charge transfer complexes;

FIG. 65 shows the geometry of the JA-14 rotor of Beckman Coulter; and

FIG. 66 shows an electron-deficient block copolymer according to the invention;

FIG. 67 shows synthesis of a poly-(styrene-co-isoprene);

FIG. 68 shows hydrogenation of the poly-(styrene-co-isoprene);

FIG. 69 shows nitration of the poly-(styrene-co-2-methylbutylene) block copolymers.

### DETAILED DESCRIPTION BY REFERENCE TO EXEMPLARY EMBODIMENTS

1.

Experiments and Syntheses

The invention will be explained in greater detail below by way of example by reference to experiments and syntheses. The numbers in square brackets refer to quotes from literature, i.e. citations. By making reference to such quotes in literature, the content thereof, as addressed in the context of the said literature reference, is intended to be part of the present disclosure.

1.1

First Complex Formation with Electron-Deficient Compounds

In order to find the electron-deficient compound that has the greatest electron deficiency among all those low-molecular electron-deficient compounds examined here, experiments were firstly carried out with the electron donor naphthalene. In these experiments the colour change, which arises with the formation of charge transfer complexes, was observed. Solutions of 0.1 mol/L of the electron acceptors and donors were produced. Chloroform was used as solvent. Subsequently, each 10 mL of the acceptor solution was mixed with respective 10 mL of the naphthalene solution in a 100 mL beaker. These samples were then stirred by means of a magnetic stirrer and a stir bar for 15 minutes at 400 rpm (rotations per minute). The colour changes are shown in section 2.1.

These solutions were then left open in the flue hood (100 mL beaker), whereby the solvent could evaporate and crystals could form. In preliminary experiments in a Petri dish (φ 90 mm), the evaporation of the solvent was realised too quickly and no crystals could form.

1.2

UV/Vis Measurements

By means of the UV/Vis measurements, the stoichiometry and formation constant of each of the charge transfer complexes between the donors naphthalene, pyrene and coronene and the electron-deficient compounds DDQ (2,3-dichloro-5,6-dicyano-1,4-benzoquinone) and TCNE (tetracyanoethylene) were determined. For this, two different series of measurements were carried out.

In order to determine the stoichiometry, donor and acceptor solutions of the same concentration were produced in a respective 100 mL round-bottom flask in chloroform (as solvent). The solutions of DDQ, TCNE and coronene were heated to 50° C. and additionally stirred by means of a magnetic stirrer and a stir bar at 400 rpm (rotations per minute). In addition, a reflux condenser with drying tube was placed on the round-bottom flask. By heating the solutions, it was possible to reach higher concentrations.

Subsequently, different quantities of these samples were mixed in 3 mL quartz cuvettes (see Table 2). The extinction of these samples was then measured at 25° C. by means of a UV/Vis spectrometer (see section 3.1.4).

TABLE 2
Quantities used for the UV/Vis measurement
to determine the stoichiometry

| | Donor solution | Acceptor solution |
|---|---|---|
| Measurement | [mL] | [mL] |
| 1 | 0.3 | 2.7 |
| 2 | 0.6 | 2.4 |
| 3 | 1.0 | 2.0 |
| 4 | 1.2 | 1.8 |
| 5 | 1.5 | 1.5 |
| 6 | 1.8 | 1.2 |
| 7 | 2.0 | 1.0 |
| 8 | 2.4 | 0.6 |
| 9 | 2.7 | 0.3 |

In contrast, to calculate the formation constants, solutions were prepared in chloroform, wherein either the acceptor or the donor concentration was greatly increased. In most cases, due to the low solubility of the low-molecular electron-deficient compounds, the donor concentration was increased. The solutions were prepared again in a 100 mL round-bottom flask. The samples of DDQ, TONE and coronene, as for the previous measurements, were produced by heating and then different quantities (see Table 3) were transferred to 3 mL cuvettes. The volume of the solution with lower concentration was maintained constant and the volume of the other solution was gradually increased. Subsequently the cuvette was filled with chloroform. Then the extinction of all samples up to 25° C. was measured again.

TABLE 3
Examples of quantities used for the UV/Vis measurement
to determine the formation constant

| | Donor solution | Acceptor solution | Chloroform |
|---|---|---|---|
| Measurement | (mL) | (mL) | (mL) |
| 1 | 0.6 | 0.3 | 2.1 |
| 2 | 0.9 | 0.3 | 1.8 |
| 3 | 1.2 | 0.3 | 1.5 |
| 4 | 1.5 | 0.3 | 1.2 |
| 5 | 1.8 | 0.3 | 0.9 |
| 6 | 2.1 | 0.3 | 0.6 |
| 7 | 2.4 | 0.3 | 0.3 |
| 8 | 2.7 | 0.3 | — |

When carrying out the UV/Vis measurements, a discolouration, or change of colour, of the solutions of naphthalene and pyrene in chloroform at high concentrations was found. The colourless naphthalene solution was blue after a few hours of storage and the yellow/orange pyrene solution turned green.

In order to be able to exclude the influence of oxygen and thus oxidation of these two electron donors in the solution, different solutions of naphthalene (0.8 mol/L) and pyrene (1.3 mol/L) in chloroform were prepared. One solution was prepared in air and a further solution in argon atmosphere.

In the case of the latter solutions, the chloroform was additionally rinsed with argon and kept water-free with a molecular sieve (see section 3.1.4).

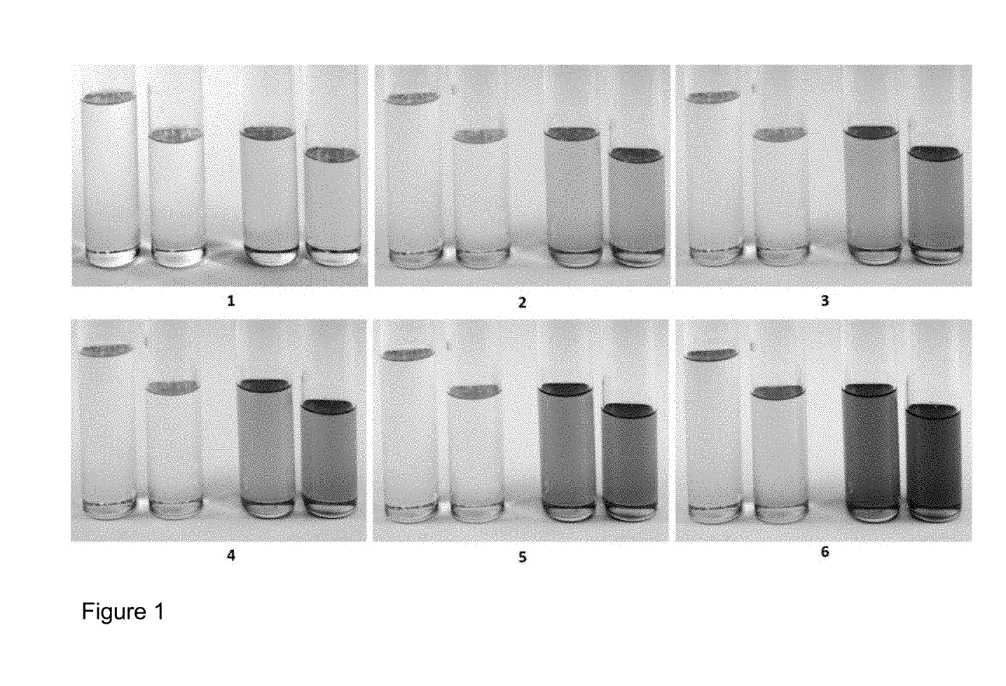

Subsequently all the solutions were illuminated with three spiral daylight lamps of Walimex (125 W) and the colour changes were photographed (see section 3.1.4). The results of these experiments are shown in FIG. 1.

In these photographs, the outermost lying samples changed colour first. This was due to the inhomogeneous irradiation of the samples. The light was guided from the left, from the right and from above onto the solutions.

The photographic documentation of the colour changes in FIG. 1 shows that all the solutions change colour following irradiation with the spiral daylight lamps. These colour changes remained even after a few weeks of light exclusion. By observing the colour changes of all the solutions, it was thus possible to rule out the effect of oxygen on the discolouration.

One possible reason for the change in colour of the solutions could be the formation of radical cations. An energy supply through light irradiation leads, in the case of aromatics (Ar) pyrene and naphthalene, to an ionisation. A radical cation (Ar*⁺) thereby arises via the triplet status of the aromatic, which can react with a further aromatic to form a dimer radical cation (Ar₂*⁺) [1] [2] [3] [4].

Ar*⁺+Ar→Ar₂*³⁰

Both in the case of the radical cations and also the dimer radical cations, new extinction bands can be measured. However, these newly formed cations have a very short half-life, e.g.:

Pγ₂*⁺:τ_{1/2}=51 ns

with a pyrene concentration of 3 mmol/L and an irradiation duration of 5 ns by means of a laser [1].

Another explanation for the change in colour could be the formation of uncharged radicals

Ar* and ArH

which should also have new extinction bands.

$$Ar - H {\to }^{h \cdot v} {Ar}^{*} + {H}^{*}$$

$$Ar + {H}^{*} {\to }^{h \cdot v} {ArH}^{*}$$

It is assumed in the experiments carried out that more radicals formed due to the higher concentrations (e.g. pyrene 1.3 mol/L) and the longer period of illumination, these radicals then leading to a greater change in colour of the solution.

However, the experiments shown in FIG. 1 are not consistent with the formation of short-lived radical cations, as the change in colour of the pyrene and naphthalene solutions remained over a time period of several weeks (in contrast with a half-life time of the radical cations of

τ_{1/2}=51 ns

The half-life of the postulated radical aromatic is not known.

These factors were not examined any further here. For an analysis, an electron spin resonance spectroscopy (ESR) would be necessary. The influence of the colour change of the solutions on the UV/Vis measurements was disregarded. No extinction could be measured in the wavelength range under consideration for these electron donors and the change in colour arose only after storage of the solutions.

1.3

Nitration of Polystyrene

In this task, polystyrene was nitrated by three different variants. Experiments were carried out with mononitration, dinitration and trinitration. These experiments will be summarised in this section.

1.3.1

Mononitration

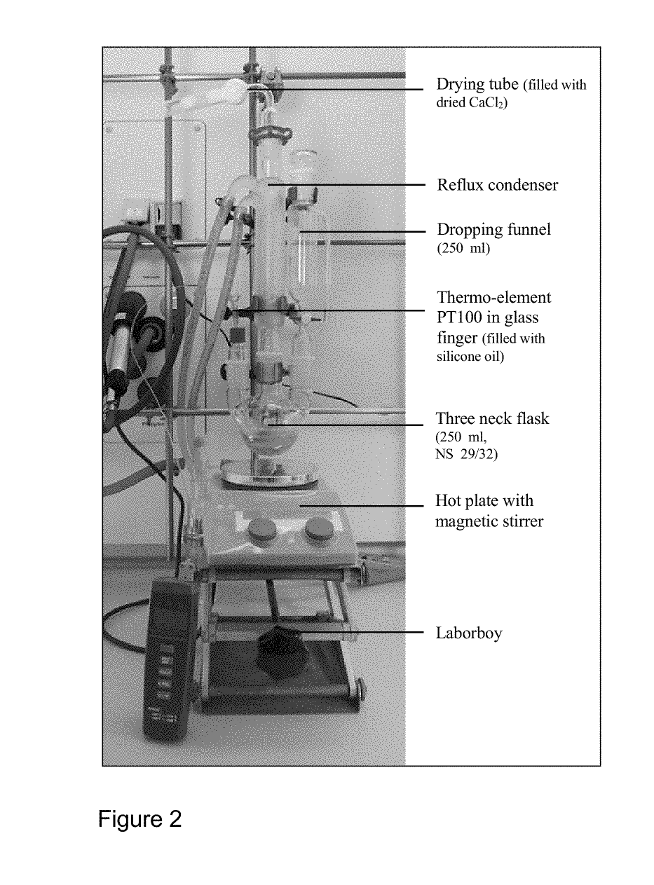

The Set-Up for the Mononitration of Polystyrene is Shown in FIG. 2.

For nitration, firstly 3 g of polystyrene and 60 mL of chloroform were added to a 250 mL three-neck flask. During continuous stirring by means of a magnetic stirrer, the polystyrene was dissolved in the chloroform. The polystyrene solution was cooled with ice water down to 5 to 10° C. 1

Meanwhile, the nitration acid was prepared in an Erlenmeyer flask. Firstly, 2.5 mL of water, then 3.5 mL of fuming nitric acid and, finally, 7.2 mL of concentrated sulfuric acid were added to the Erlenmeyer flask. The flask was continuously cooled with ice water and the solution was stirred for five minutes at 400 rpm.

Subsequently, the nitration acid was poured into the dropping funnel and added slowly in drops to the polystyrene solution. The solution was stirred at 400 rpm and cooled with ice water down to 5 to 10° C. During the drop-by-drop addition of the nitration acid, the colourless polystyrene solution turned brown. The nitration acid was added over a period of 45 minutes.

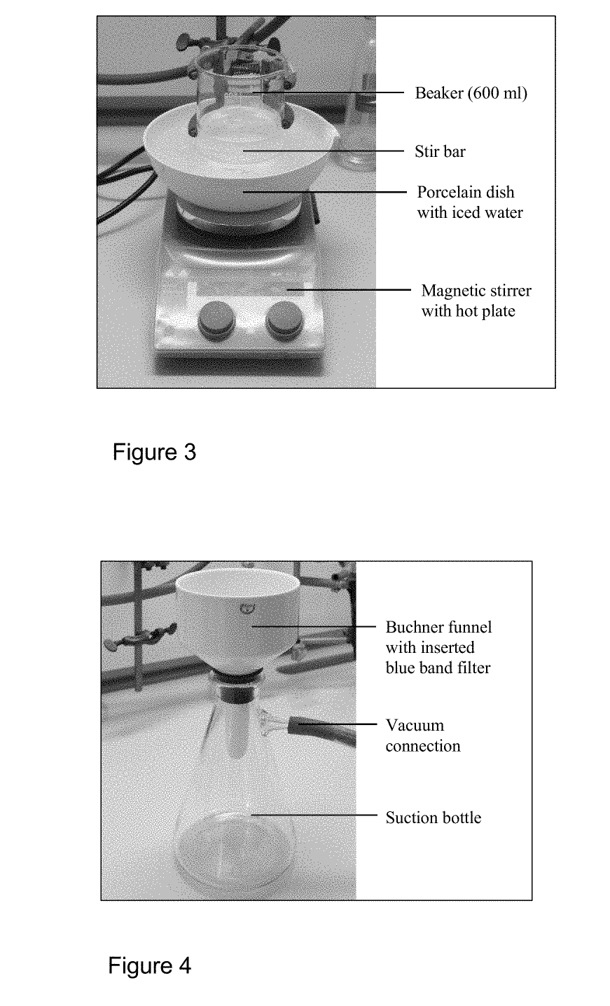

The solution was then stirred for a further three hours at 5 to 10° C. and, while stirring (600 rpm), was then precipitated into 150 mL of ice-cooled 2-propanol (see FIG. 3). The solution turned yellow and a yellow flake formation was observed. In addition, a yellow clotted precipitate had formed in the rapid precipitation process.

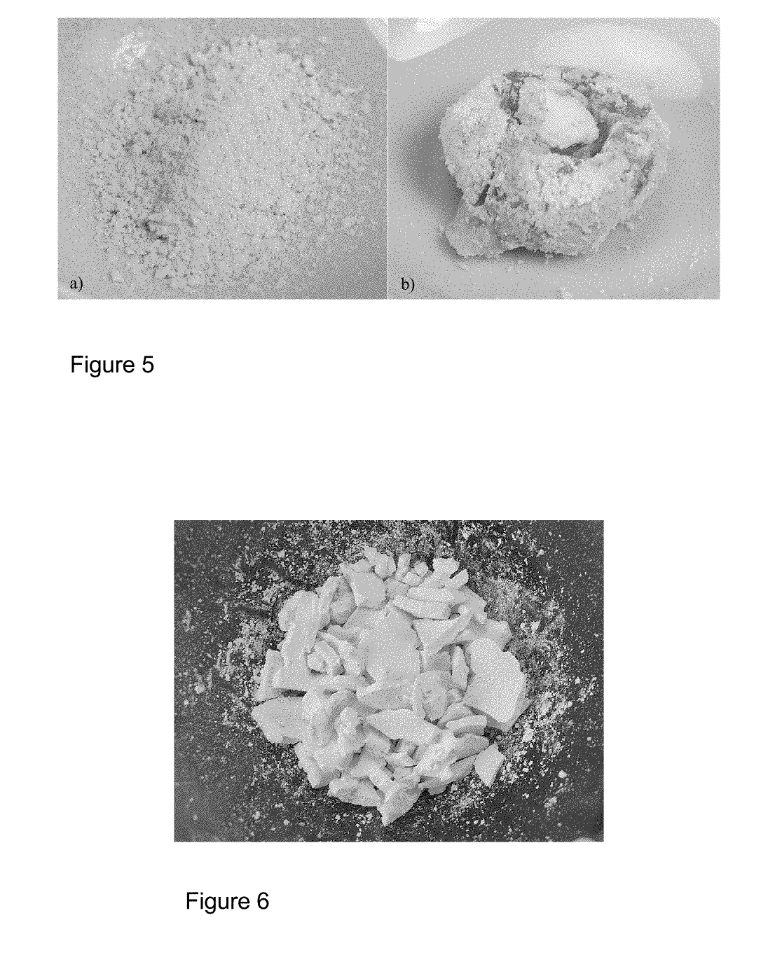

After ten minutes of slow stirring (300 rpm), the precipitate was filtered off by means of Büchner funnel (blue band filter) (see FIG. 4) and washed with 2-propanol. The residue (see FIG. 5) was dried on a hot plate in a porcelain dish (φ 160 mm) until weight constancy was reached.

For re-crystallisation this precipitate was then dissolved with continuous stirring in 100 mL of N,N-dimethylformamide and, after one hour, this solution was precipitated very slowly through feeding via a glass rod in deionised water. The water bath was stirred at 400 rpm at a temperature of 40° C. Once again, yellow flakes formed and the water turned slightly yellow.

After four hours, the precipitate was filtered off by means of Büchner funnel (blue band filter) and washed with water and 2-propanol. The yellowish precipitate was dried on a hot plate in a porcelain dish (P 160 mm) until weight constancy (2.45 g) was reached. This precipitate is shown in FIG. 6.

Tables 4 and 5 show the yields and the results of the elemental analysis of this reaction product.

TABLE 4
Yield from mononitration of polystyrene

| | Yield at complete | Literature value | |
|---|---|---|---|
| Yield [g] | mononitration [%] | [%] | Source |
| 2.45 | 57.05 | 80 | [5] |

TABLE 5
Results of the elemental analysis of the reaction product of mononitration
Elemental analysis:

| | | | |
|---|---|---|---|
| Elemental analysis: | Element | Measured | Calculated |

| | | |
|---|---|---|
| C | 86.9% | 64.4% |
| H | 7.1% | 4.7% |
| N | 1.7% | 9.4% |
| O | 4.3% | 21.5% |

1.3.2 Dinitration

Dinitration was carried out based on the mononitration. The set-up for mononitration was also used for dinitration (see FIG. 2). At the start, 5 g of polystyrene was dissolved in 50 mL of chloroform in a three-neck flask with continuous stirring at 400 rpm by means of a magnetic stirrer (stir bar). The polystyrene solution was cooled by ice water to 5-10° C.

During the cooling the nitration acid was prepared in an Erlenmeyer flask, also with ice cooling and continuous stirring. Firstly, 10 mL of fuming nitric acid and then 14 mL of concentrated sulfuric acid were added to the Erlenmeyer flask.

After being stirred for a short time, the nitration acid was poured via a glass funnel into a 250 mL dropping funnel and then added in drops to the polystyrene solution. The temperature of the solution was thereby to be between 5 and 10° C. The temperature control was performed by a PT100 thermal element in a glass finger filled with silicone oil. Already after the first addition of the nitration acid, brown flakes formed. In addition, the solution turned brown after a few seconds.

The temperature control was very difficult in this nitration process. While adding the nitration acid drop by drop, the temperature increased up to 21° C. due to the extremely exothermic reaction. For this reason, the drop feeding was stopped at one point and the temperature thereby slowly fell back down to 7° C. Subsequently the remaining nitration acid was added. The further addition of nitration acid did not cause any further change in the temperature of the solution. It was assumed that the reaction did not start up again.

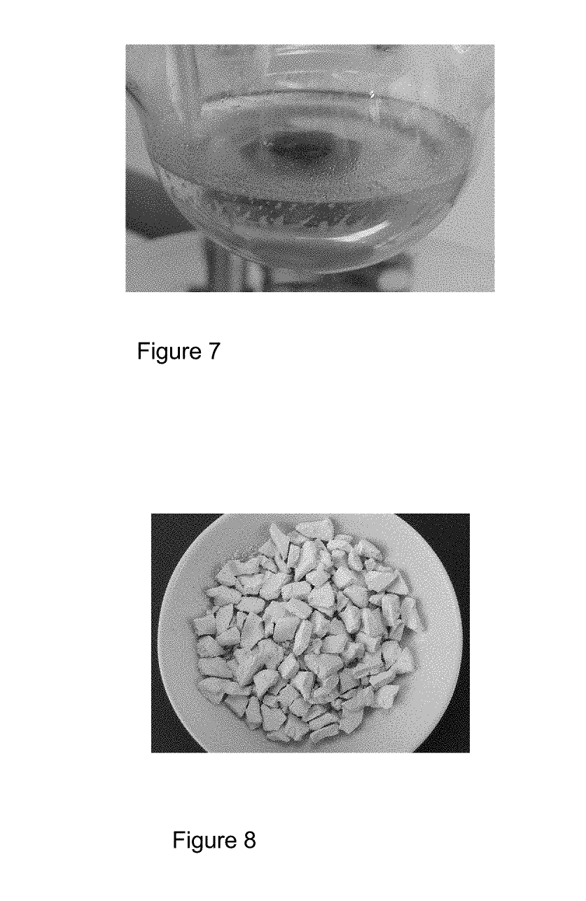

After all the nitration acid had been added, the ice bath was removed and the temperature increased slowly to 27° C. The solution was stirred once again for 3 hours at 400 rpm (stir bar). The brown flakes, which had formed during the drop feeding, turned into a sticky brown clotted precipitate, which grew increasingly during the stirring (see FIG. 7).

After the three hours of reaction time, the solution was precipitated slowly and with continuous stirring (600 rpm) into 200 mL of ice-cooled 2-propanol. The 2-propanol was in a 500 mL beaker, which was provided with a stir bar. The brown precipitate had to be previously scraped off the bottom of the three-neck flask. This solution was stirred for a further three hours and the larger flakes in the solution were greatly reduced in size.

Subsequently, the precipitate was filtered off by means of Büchner funnel and blue band filter twice and washed with 2-propanol. Then, this precipitate was transferred for re-crystallisation to a 250 mL round-bottom flask and dissolved through the addition of 100 mL of N,N-dimethylformamide. The solution immediately turned brown and the solid residue dissolved quickly.

After 17 hours of stirring at 300 rpm, the solution was transferred very slowly via a glass rod to a beaker filled with 400 mL of deionised water. The water was heated by means of a hot plate to 40° C. and stirred at 600 rpm. Upon precipitation, yellow-orange flakes immediately formed in the solution.

The solution was stirred for a further four hours at 400 rpm and at 40° C. Subsequently the precipitate was filtered by means of Büchner funnel (blue band) and washed firstly with deionised water and then with 2-propanol.

The precipitate was dried until weight constancy (7.78 g) was reached in a porcelain dish (φ 160 mm) on a hot plate at 80° C. FIG. 8 shows this sample after the drying process. Table 6 and Table 7 show the yield and the results of the elemental analysis.

TABLE 6
Yield from the dinitration of polystyrene in chloroform

| | Yield at complete | Literature value | |
|---|---|---|---|
| Yield [g] | mononitration [%] | [%] | Source |
| 7.78 | 83.39 | 80 | [5] |

TABLE 7
Results of the elemental analysis of the reaction
product of dinitration of polystyrene in chloroform

| | | | |
|---|---|---|---|
| Elemental analysis: | Element | Measured | Calculated |

| | | |
|---|---|---|
| C | 57.4% | 49.5% |
| H | 4.1% | 3.1% |
| N | 11.3% | 14.4% |
| O | 27.2% | 33.0% |

Since brown flakes had formed during the dinitration of polystyrene in chloroform, experiments were also carried out with 1,2-dichloroethane as solvent. Wth this nitration process, the temperature control was also very problematic.

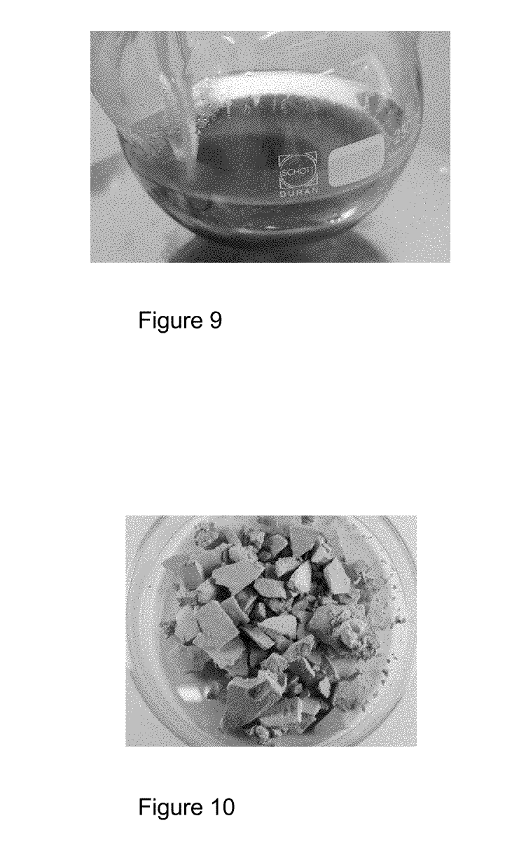

With this solvent too, flakes immediately precipitated from, i.e. “fell out of”, the solution and a sticky, clotted precipitate also formed in the solution (see FIG. 9). However, a different colour change in comparison with the dinitration in chloroform was observed. Brown-green flakes were formed, which then settled at the bottom of the three-neck flask.

The dried nitrated sample was also a different colour from that of the reaction product of dinitration in chloroform (see FIG. 10). For verification purposes, the samples from the dinitration in chloroform and also the samples from nitration in 1,2-dichloroethane were analysed.

TABLE 8
Yield from the dinitration of polystyrene in 1,2-dichloroethane.

| | Yield at complete | Literature value | |
|---|---|---|---|
| Yield [g] | dinitration | [%] | Source |
| 7.02 | 75.30 | 80 | [5] |

TABLE 9
Results of the elemental analysis of the reaction product
of the dinitration of polystyrene in 1,2-dichloroethane.

| | | | |
|---|---|---|---|
| Elemental analysis: | Element | Measured | Calculated |

| | | |
|---|---|---|
| C | 59.1% | 49.5% |
| H | 4.2% | 3.1% |
| N | 10.9% | 14.4% |
| O | 25.7% | 33.0% |

1.3.3

Trinitration

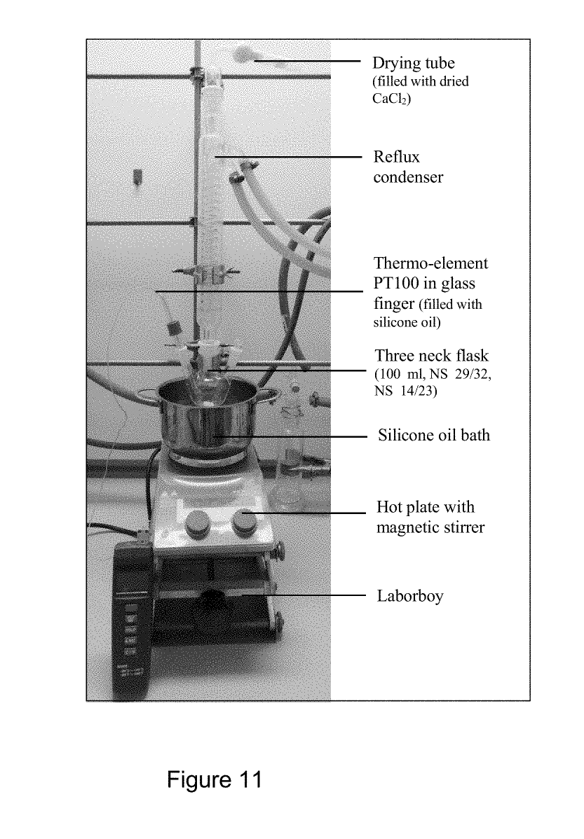

The set-up for trinitration virtually corresponded to the set-up for dinitration. However, in this case, the dropping funnel was not required. Due to the smaller preparation, only a 100 mL three-neck flask was used (see FIG. 11).

For the trinitration, the already nitrated polystyrene from the dinitration in chloroform was used. From this sample, 1 g was ground with a mortar and a pestle and transferred to the three-neck flask.

Additionally, 5 mL of concentrated sulfuric acid was poured into the three-neck flask and then the flask was placed in an ice bath. The polystyrene dissolved in the sulfuric acid and was stirred continuously at 400 rpm by means of a magnetic stirrer (stir bar). The temperature, which was 6° C. at the start of the reaction, was monitored with a thermal element in the glass temperature finger.

During ice cooling, 2.5 g of nitronium tetra fluoroborate was quickly transferred with a spatula to the three-neck flask. A further 5 mL of concentrated sulfuric acid was additionally transferred with a glass pipette.

A reflux condenser with drying tube (CaCl₂ filling) was then placed on the three-neck flask and the third neck was closed with a glass cap. The ice bath was removed from the flask and the temperature slowly increased up to 20° C. The polystyrene solution was brown at this time and the polystyrene was completely dissolved.

Subsequently, a silicon oil bath was placed under the three-neck flask. An aluminium foil was wrapped around the three-neck flask and the silicon oil bath. The silicon oil was then heated with a hot plate. After three hours the temperature of the polystyrene solution was 150° C.

After a further three hours of stirring (at 150° C.), solid, dark brown flakes were visible at the bottom of the three-neck flask. In order to re-dissolve these brown flakes, a further 10 mL of concentrated sulfuric acid was added to the solution. The temperature thereby decreased to 120° C. and then increased back up to 150° C. However, the brown solid components, which were stuck to the bottom of the three-neck flask, did not re-dissolve. For a complete nitration, the nitrated sample should be completely dissolved [6].

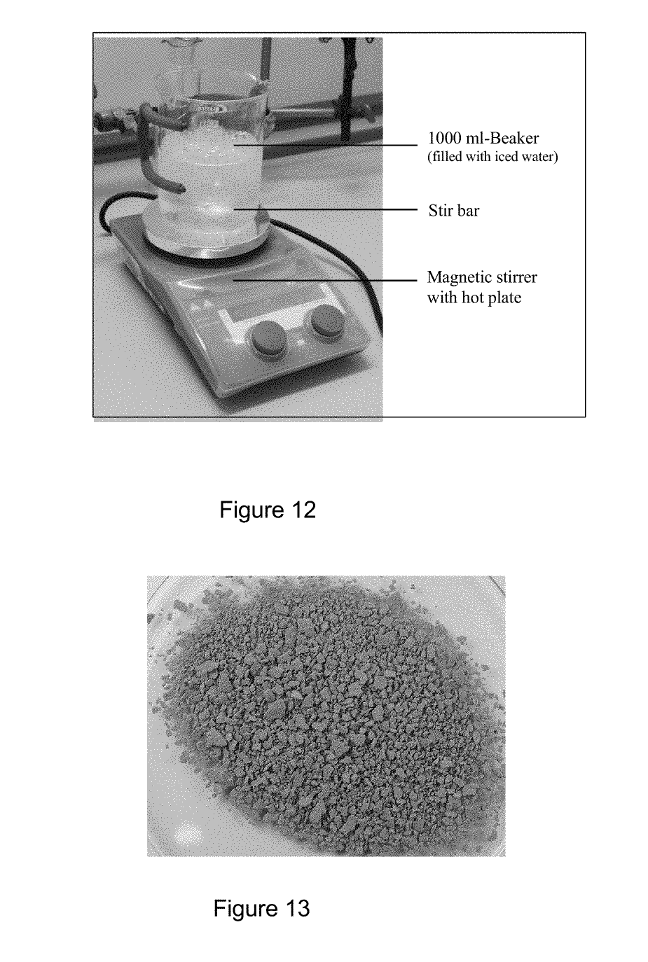

After a total of 3.8 hours of reaction time, the solution was transferred very slowly via a glass rod to a beaker (1000 mL) containing 500 mL of ice water (see FIG. 12). The ice water was continuously stirred at 600 rpm. In this precipitation process, with the formation of gas, a very large quantity of heat was released, which led to a foam formation at the water surface. The water thereby turned orange and the precipitate became dark brown.

The water continued to be stirred for a total of 17 hours at 300 rpm. Subsequently, the precipitate was filtered off by means of Büchner funnel (blue band) and washed with a five per cent sodium-hydrogen-carbonate solution.

The brown precipitate was dried on a hot plate in a porcelain dish (φ 160 mm) at 80° C. The weight of the sample at the end was 0.83 g. This precipitate is shown in FIG. 13. The yield and the results of the elemental analysis are shown in the following tables.

TABLE 10
Yield from the trinitration of dinitrated polystyrene

| | Yield at complete | Literature value | |
|---|---|---|---|
| Yield (g) | trinitration | [%] | Source |
| 0.83 | 67.09 | 49.3 | [6] |

TABLE 11
Results of the elemental analysis of the reaction product
of the trinitration of dinitrated polystyrene

| | | | |
|---|---|---|---|
| Elemental analysis: | Element | Measured | Calculated |

| | | |
|---|---|---|
| C | 47.0% | 40.2% |
| H | 3.0% | 2.1% |
| N | 13.5% | 17.6% |
| O | 36.1% | 40.1% |

1.4

Monitoring the Sedimentation Behaviour of Carbon Nanotubes

In order to determine the influence of electron-deficient compounds on the dispersibility of CNTs in a solvent, the sedimentation behaviour of these CNTs was observed. For this, the CNTs described in section 3.1.1.2 were used.

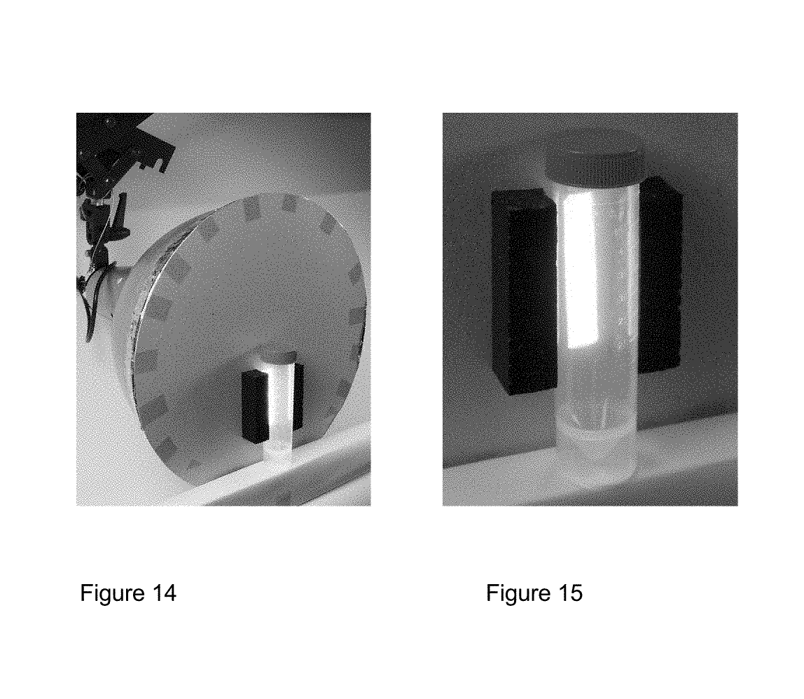

To analyse the sedimentation behaviour, a device was set up, with which the samples could be irradiated in the centrifuge tubes (see FIG. 14). For this, a lamp shade of a photo lamp (see section 3.1.4) was lined completely with aluminium foil and was then covered with a circular cardboard, which was also lined with aluminium foil. A rectangular opening (I=6 cm, b=1 cm) was cut out of the cardboard (see FIG. 15). In order to facilitate more precise placing of the centrifuge tubes, two cuboids of black dyed styrofoam were attached to the two sides of the rectangular opening of the cardboard. Through this set-up, a light bundle defined in a rectangular form was radiated through the sample.

The studies are divided below into low-molecular and high-molecular electron-deficient compounds.

1.4.1

Low-Molecular Electron-Deficient Compounds

For the studies of the low-molecular electron-deficient compounds, solutions of DDQ and TCNE in a concentration of 4 mmol/L in chloroform were produced. First of all, each 4 mg of CNTs were transferred to three 50 mL centrifuge tubes (polypropylene). Then 40 mL of DMF (sample 1) was added to one of the tubes, a further 40 mL of the DDQ solution (sample 2) was added to a further tube, and 40 mL of the TCNE solution (sample 3) to the last one.

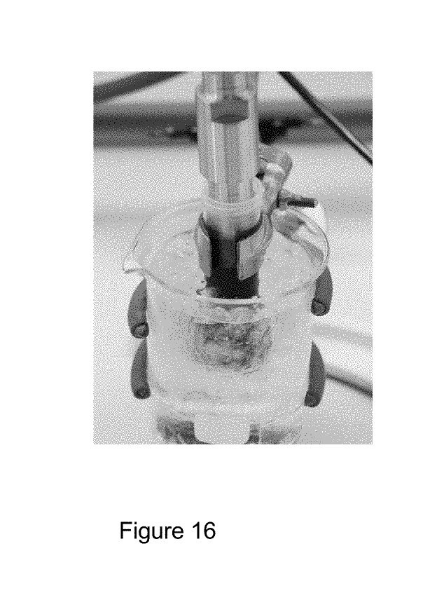

These samples were then ultrasound-treated every five minutes directly with a sonotrode (see section 3.1.4) with amplitude of 50% and a cycle of 0.5. The centrifuge tube was placed in a beaker (600 mL) filled with ice water (see FIG. 16). For comparison purposes, photographic images of the different samples were produced directly after sonication and after three days of storage.

1.4.2

High-Molecular Electron-Deficient Compounds

For the studies, firstly, five centrifuge tubes (V=50 mL, polypropylene) were dried for twelve hours at 90° C. in the furnace and subsequently placed in the desiccator for five hours. Then the empty weight of the centrifuge containers was determined.

The samples (4 to 8) shown in Table 12 were then prepared in these containers. These samples were subsequently sonicated for five minutes each at amplitude of 50% and a cycle of 0.5. The sample containers were also cooled with ice water (see FIG. 16). The solutions were black after centrifugation and had a good dispersion effect.

TABLE 12
Samples for the study of the sedimentation behaviour of CNTs under
the influence of high-molecular electron-deficient compounds

| Sample | Mass of | Additive | Mass of the | Volume |
|---|---|---|---|---|
| No. | the CNTs | used | PS used | of DMF |
| 4 | 10 mg | — | — | 40 mL |
| 5 | 10 mg | | 10 mg | 40 mL |
| 6 | 10 mg | | 10 mg | 40 mL |
| 7 | 10 mg | | 10 mg | 40 mL |
| 8 | 10 mg | | 10 mg | 40 mL |

Subsequently, these samples were centrifuged at 7000 rpm for three hours. This corresponds to a relative centripetal acceleration of 6683 g (with g=9.81 m/s²). The calculation of the centripetal acceleration is explained in section 3.5.

Photographs of the abovementioned samples were also taken directly after treatment with the sonotrode and after the centrifugation. Subsequently, in all samples, the parts of the liquid in which the CNTs were suspended were removed via a pipette. The CNTs that settled during centrifugation thereby remained in the containers. These containers were then vacuum-dried (100 mbar) for three days at 90° C. and then weighed again. In order to obtain control samples from the centrifuge tubes for comparison purposes, three further containers were dried and weighed as described above.

Problems encountered: This study was encumbered by very many defects. The balance used (see section 3.1.4) was only able to indicate masses to a precision of 0.1 mg. In addition the removal of the sample liquid from the centrifuge tubes was very difficult, as CNTs repeatedly became detached from the walls and could be very easily taken by the pipette.

2.

Results and Evaluation 2.1

Complex Formation

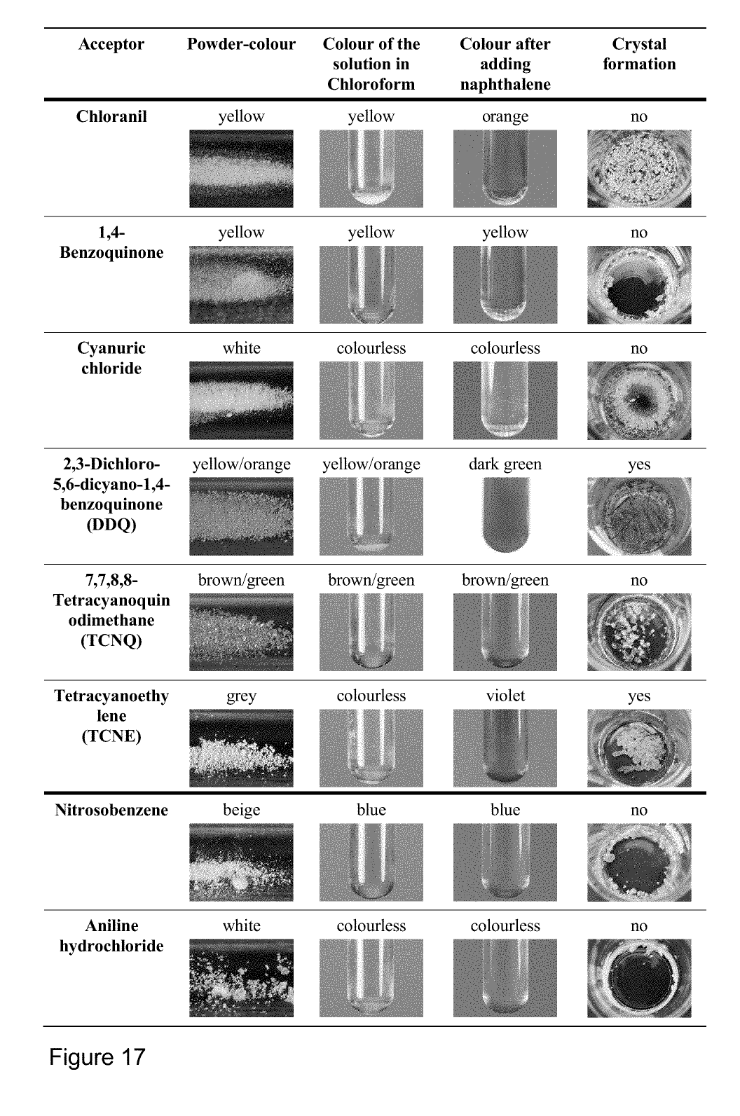

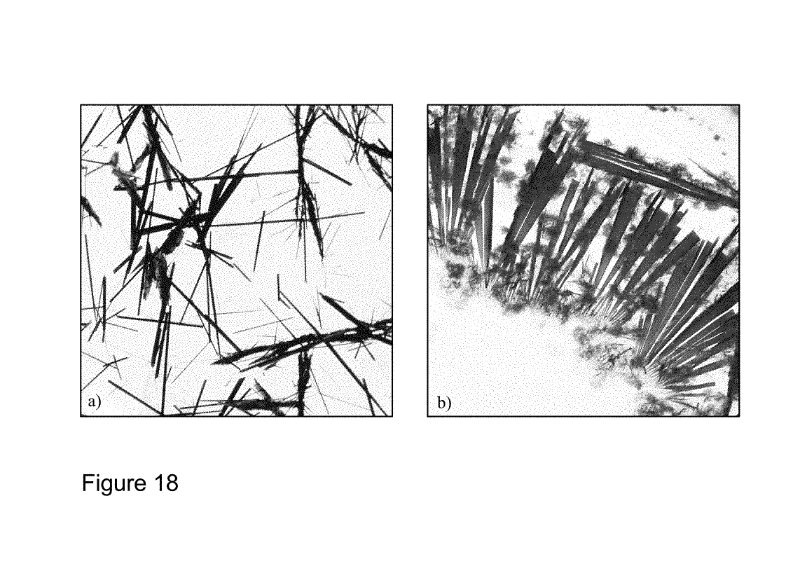

The colour change of the respective acceptor solution when the naphthalene solution was added is shown in FIG. 17. In the case of the three acceptors, namely: chloranil, DDQ and TONE, a colour change was observed after addition of the naphthalene solution. It was only with the acceptors DDQ and TONE that a crystal formation could also be observed after evaporation of the solvent. The crystals are shown in a magnified view in FIG. 18. Due to these results, the remaining measurements were only carried out with the electron-deficient compounds DDQ and TONE. The remaining electron acceptors were not further observed due to the low interaction with naphthalene.

2.2

Determination of the Stoichiometry of the Complexes

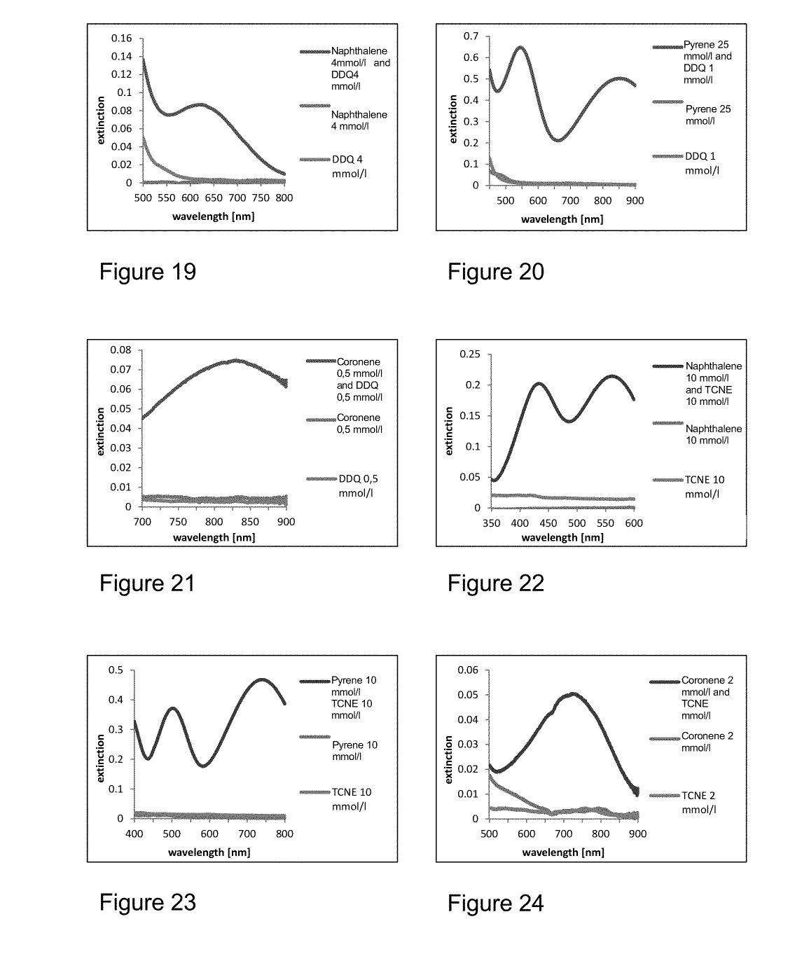

Charge transfer complexes absorb in different wavelength ranges from the respective donors and acceptors. The measured extinction ranges of the charge transfer complexes of the electron donors naphthalene, pyrene and coronene, and the electron acceptors DDQ and TONE are shown in FIGS. 19 to 24.

Wth the UV/Vis measurements, it was often the case that only very small extinction values were measured (see for example FIG. 24). This is due to the fact that higher concentrations could not be achieved in the solvent, namely chloroform. The wavelengths at which an extinction maximum arises are summarised in Table 13.

TABLE 13
Measured wavelengths at maximum extinction
of different charge transfer complexes

| | | Wavelength with maximum |
|---|---|---|
| Acceptor | Donor | extinction [nm] |
| DDQ | Naphthalene | 621 |
| DDQ | Pyrene | 539, 846 |
| DDQ | Coronene | 833 |
| TCNE | Naphthalene | 560, 430 |
| TCNE | Pyrene | 494, 738 |
| TCNE | Coronene | 725 |

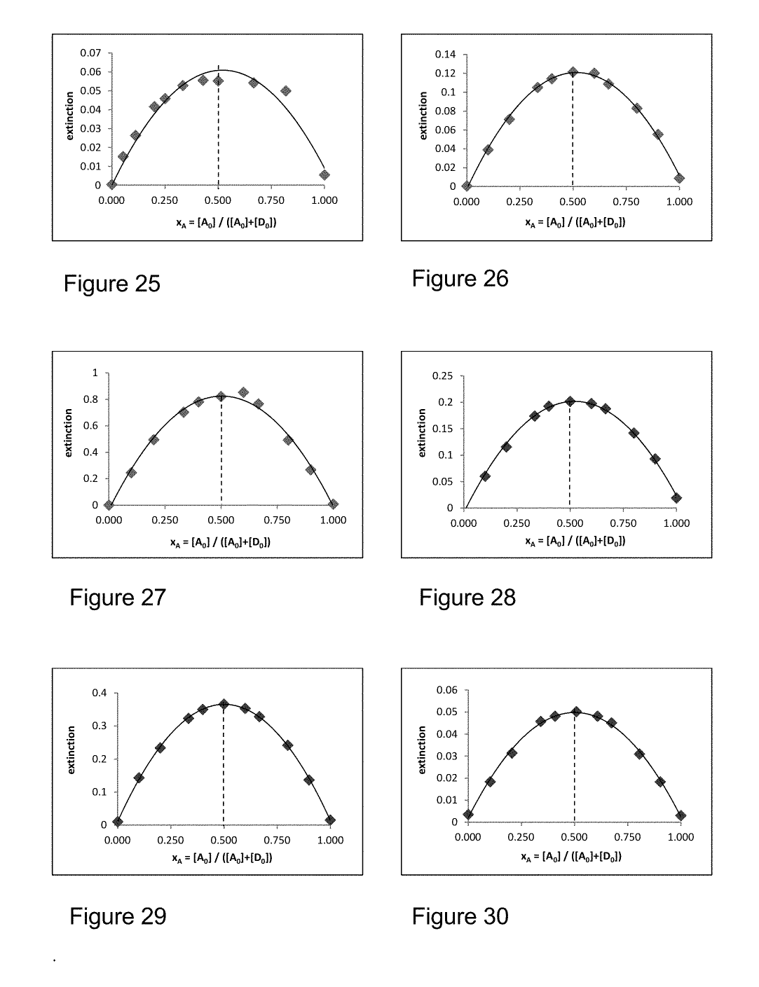

In order to determine the stoichiometry of these charge transfer complexes, the so-called job plots (see [7], [8], [9], [10]) were recorded at the abovementioned wavelengths. These are shown in FIG. 25 to FIG. 30. It can clearly be seem from these diagrams that all the complexes are present in a stoichiometry of 1:1.

2.3

Determination of the Complex Formation Constants

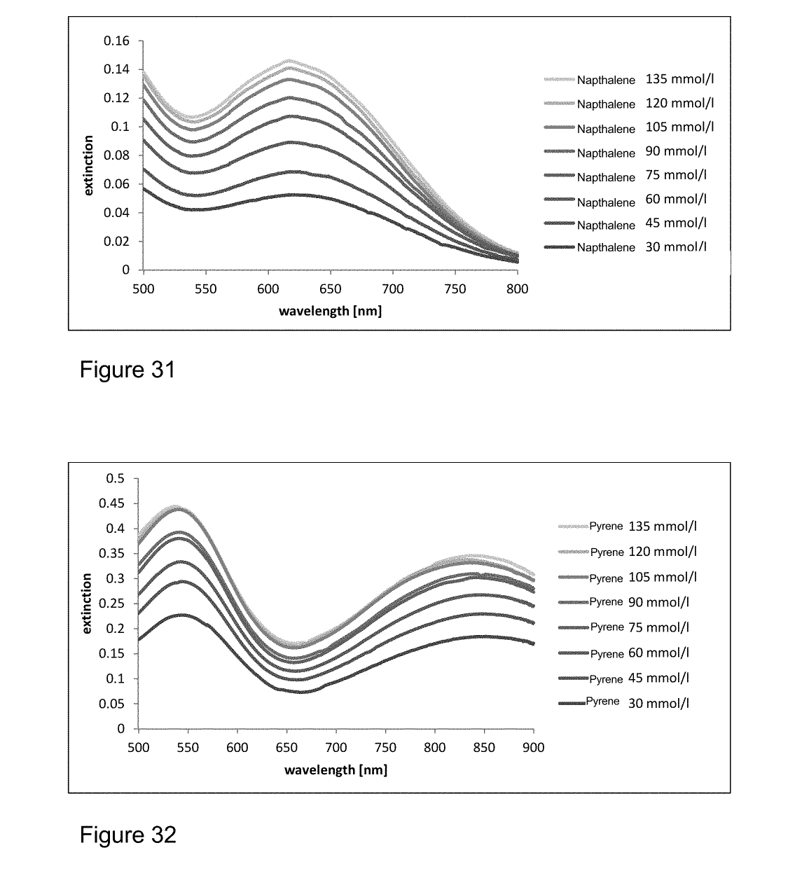

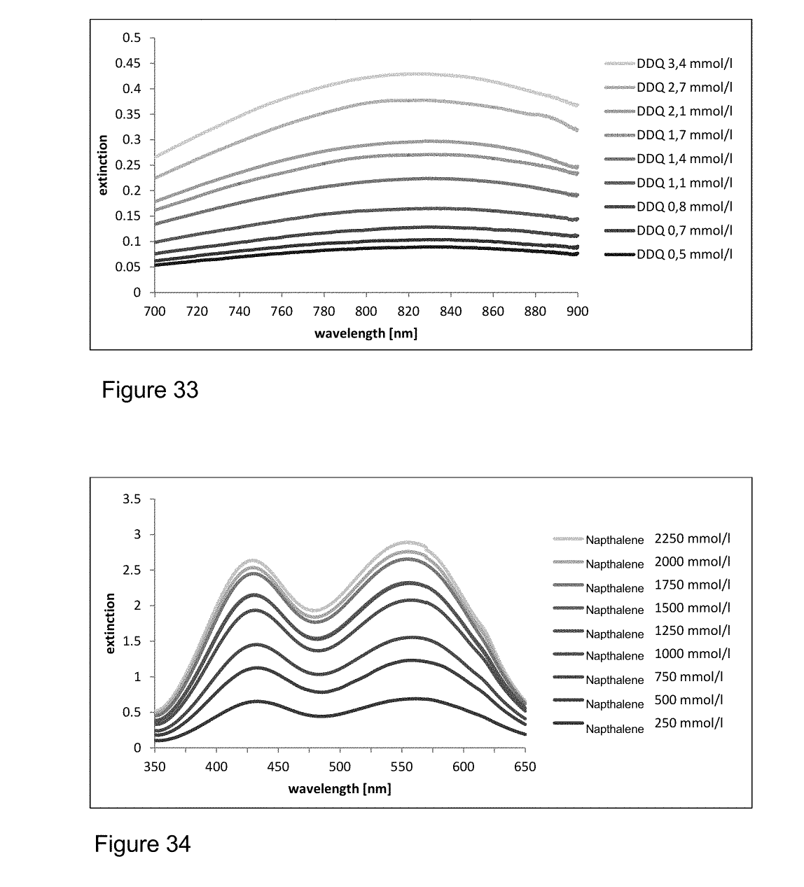

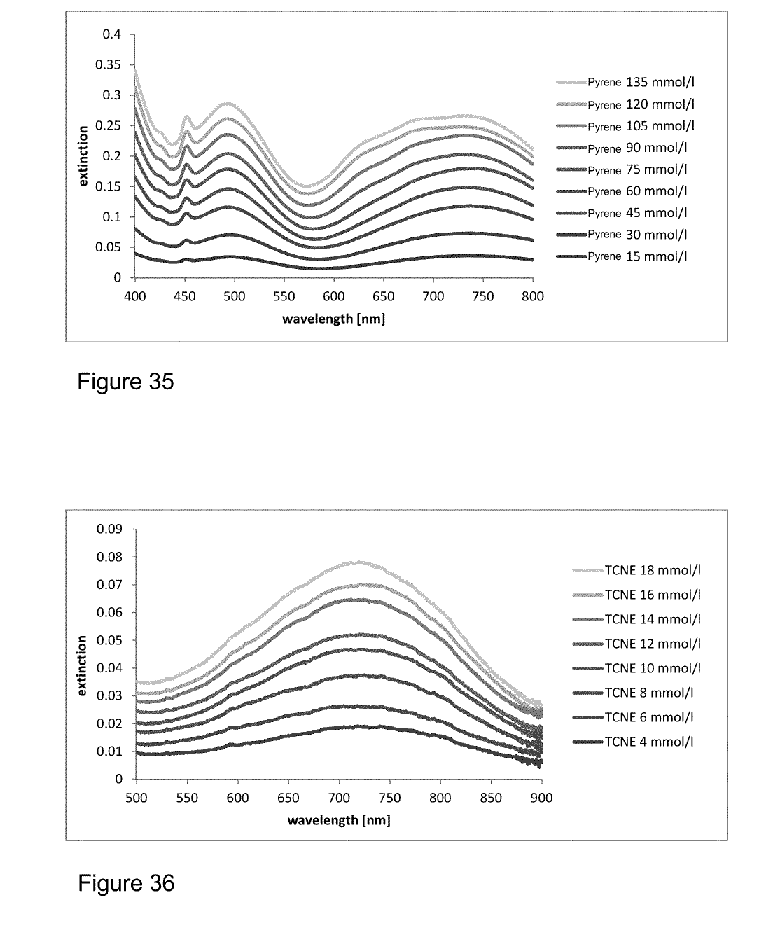

The results of the UV/Vis measurements, with a variation in the concentration of the electron acceptor or donor, are shown in FIGS. 31 to 36.

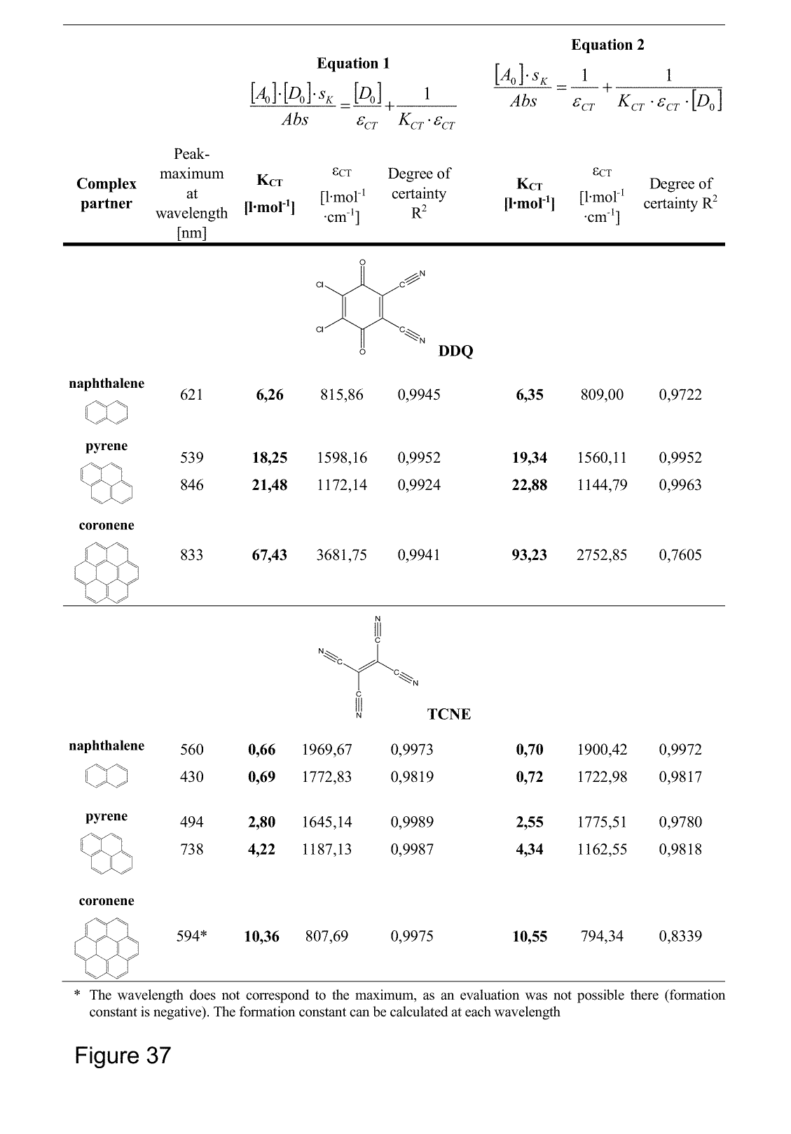

At the wavelength, at which the maximum extinction is present, the formation constant K_{CT} and the extinction coefficient E_{CT} are calculated using the Scotts form of the Benesi-Hildebrand equation (Equation 1, [11]) and the Benesi-Hildebrand equation (Equation 2, [12]). The associated diagrams are provided in section 3.3. The calculated values are shown in FIG. 37. The level of the formation constant provides an indication of the stability of the complex. The higher the constant is, the more stable is the complex [12], [13], [14].

FIG. 37 shows that the formation constants of the charge transfer complexes increase through use of larger polycyclic aromatics. In addition, it becomes clear that DDQ obviously forms greater charge transfer complexes than TONE. However, the formation constants, which have a maximum value of 93 L/mol, only reach low values (by comparison: a complex of imidazole and DDQ: K_{CT}=507.6·10³ L/mol) [15].

The complexes formed by low-molecular electron-deficient compounds with aromatics are not therefore sufficiently stable in order to develop a CNT additive based on this principle. In order to overcome this problem, it was proposed to use polymers with electron-deficient aromatics on each repeat unit [16]. The low complex formation constant thereby had to be multipliable. For this process, polynitrostyrene was selected as the electron-deficient polymer.

Since the polynitrostyrenes are not commercially obtainable, experiments were carried out on the mononitration, dinitration and trinitration of polystyrene. The results of these experiments are shown below.

2.4

Characterisation of the Nitrated Polystyrenes

To facilitate comprehension, the reaction products of mononitration, dinitration and trinitration are also described as mononitrated, dinitrated and trinitrated polystyrene. The actual degree of nitration was determined by the elemental analysis (section 6.4.4).

2.4.1

Weight Determination

For the nitration processes, different quantities of polystyrene were used. The nitrated samples were dried in each case and then weighed. These values were used to calculate the yield of nitrated polystyrene at 100% nitration. These values are summarised in the following table.

TABLE 14
Specified quantities and the yield from
the different nitration processes

| | Mass of | Nitrated | Yield at | Literature |
|---|---|---|---|---|
| | polystyrene | polystyrene | complete | values for |
| | used at weigh-in | obtained | nitration | the yield |
| | [g] | [g] | [%] | [%] |
| Mononitration | 3.0004 | 2.4513 | 57.05 | 80 [5] |
| Dinitration in | 5.0006 | 7.7816 | 83.39 | 80 [5] |
| chloroform | | | | |
| Dinitration in | 5.0038 | 7.0241 | 75.30 | 80 [5] |
| 1,2-dichlor- | | | | |
| ethane | | | | |
| Trinitration | 1.0023 | 0.8283 | 67.09 | 49.3 [6] |

The yield in the case of mononitration is comparatively low (57.05%). A yield of 80% is indicated in the literature. [5] However, this value applies to a complete mononitration. Section 2.4.4 shows the actual degree of nitration.

2.4.2

Fourier Transformation—Infrared Measurements

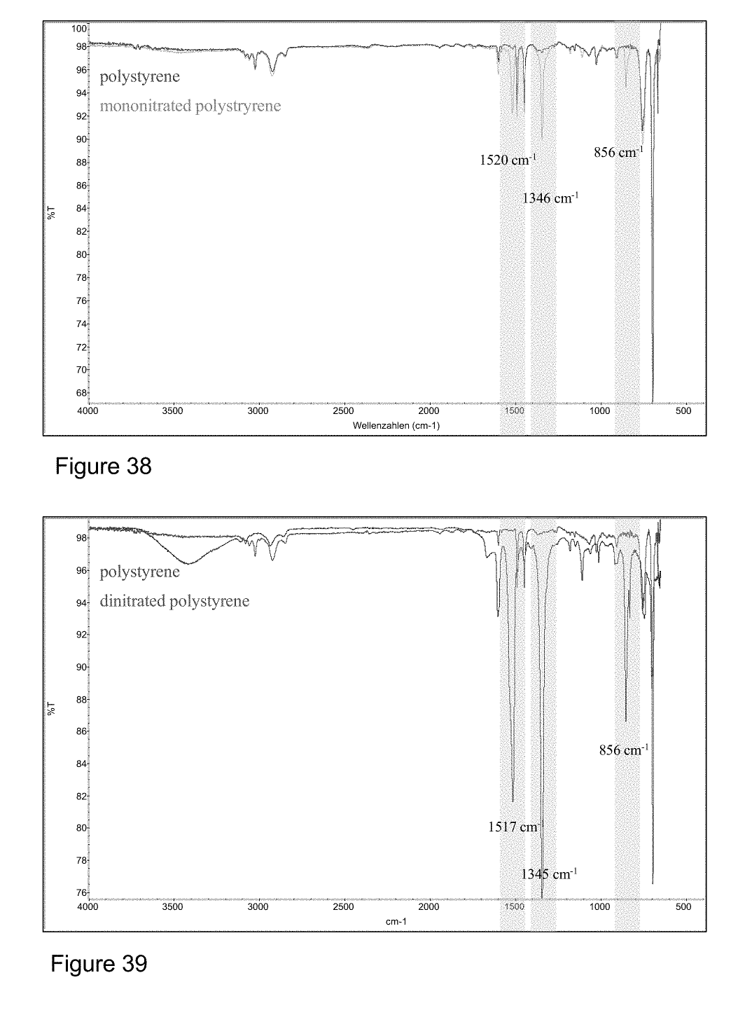

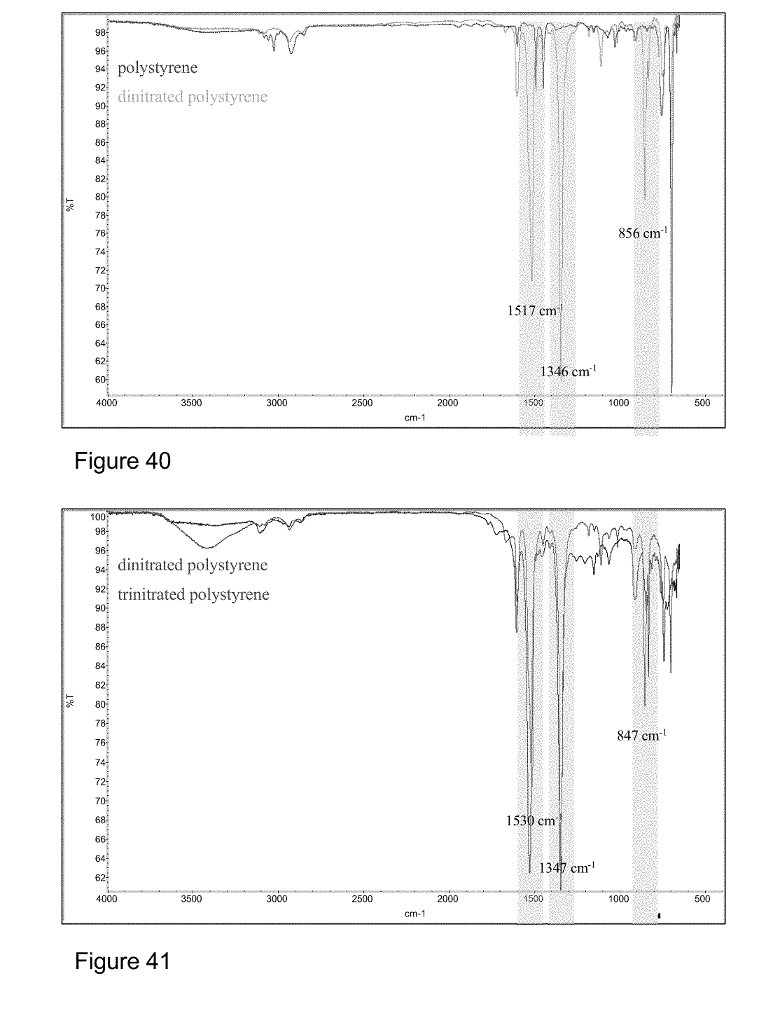

The samples produced were then characterised by a FT-IR measurement. The recorded spectra could not be compared with the database. No spectra of mononitrated, dinitrated or trinitrated polystyrene had been stored in the database. For this reason, in addition to the FT-IR spectra of the nitrated polystyrenes, spectra of the polystyrenes used were also produced. The comparisons of these samples can be seen in FIG. 38 to FIG. 41.

In all the spectra, new bands can be observed in comparison with the polystyrene used. These indicate a successful nitration of the polystyrenes. The characteristic bands for nitro groups at 1345 cm⁻¹ and 1520 cm⁻¹ can be found in the spectra of the nitrated polystyrenes. However, these two bands are very small in the mononitrated polystyrene (see FIG. 38). A further new band can be seen in the mononitrated and dinitrated samples at 856 cm⁻¹. This is characteristic for a 1,2,4-substituted benzene ring. This indicates a dinitration of the polystyrene [17]. In addition, this band is moved in the trinitrated polystyrene and is 847cm⁻¹.

2.4.3

GPC Measurements

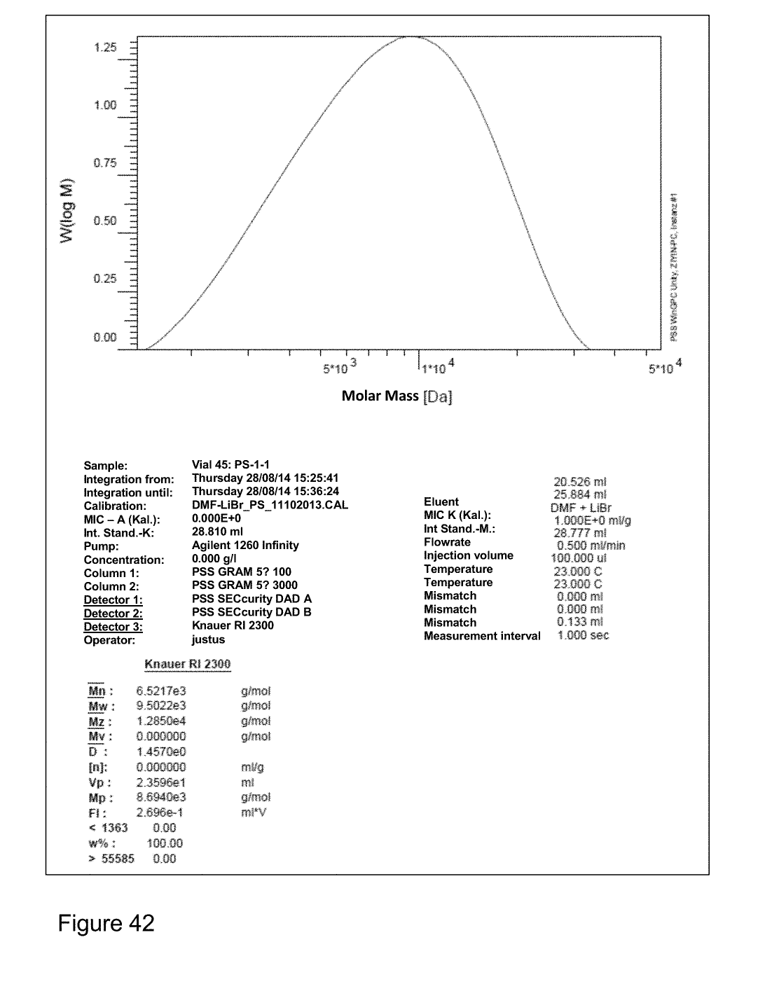

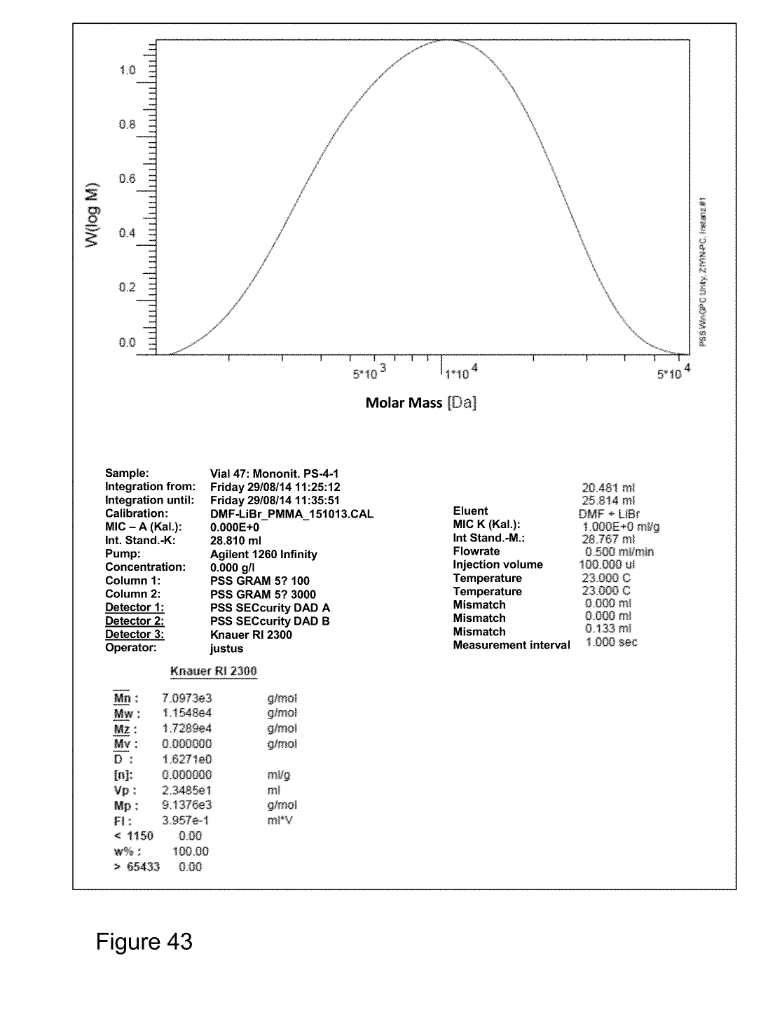

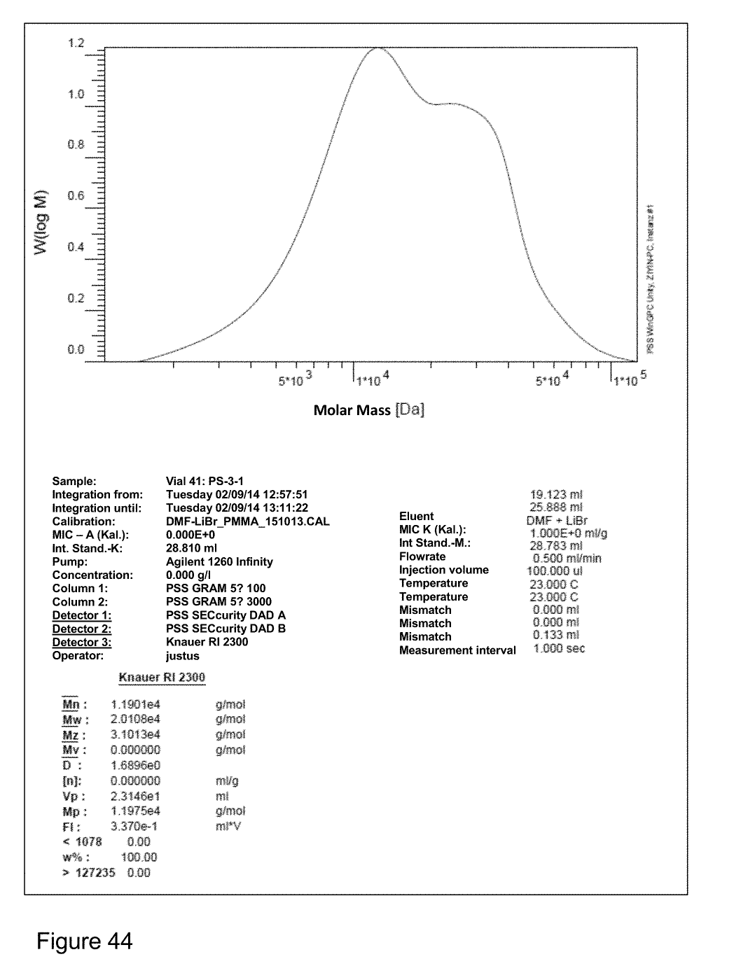

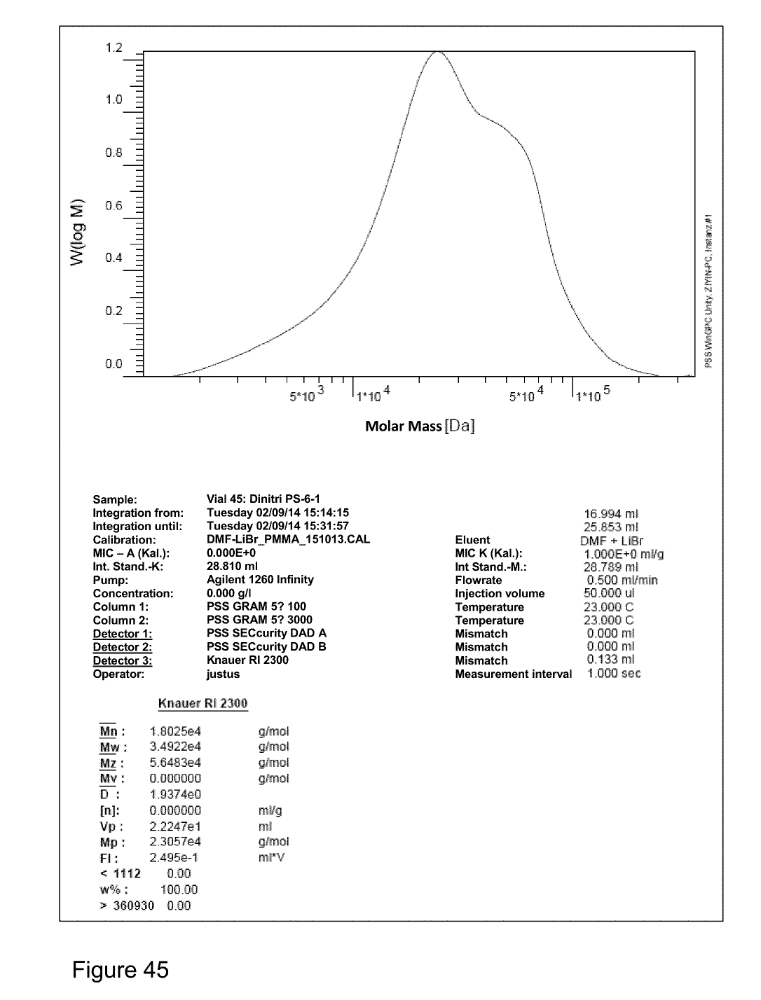

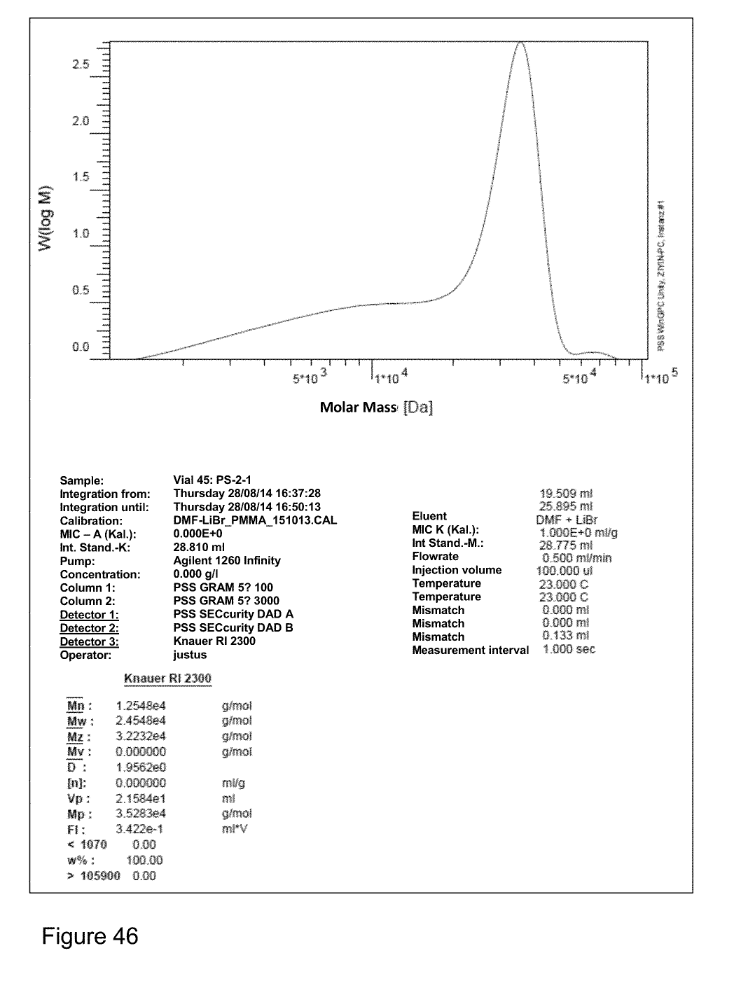

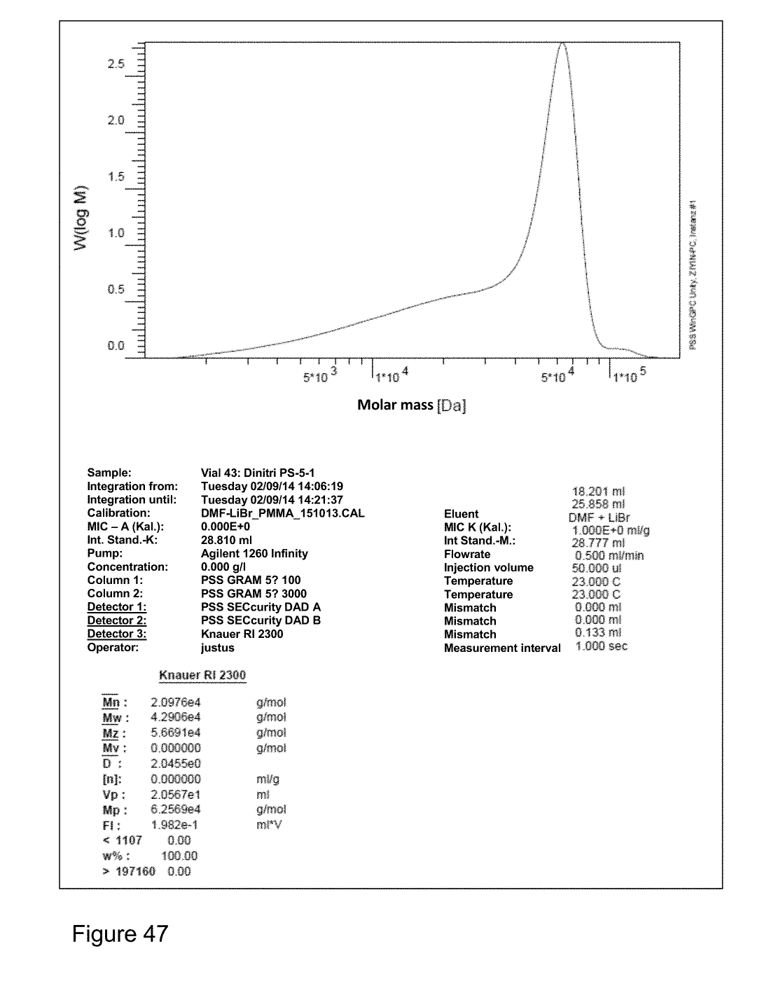

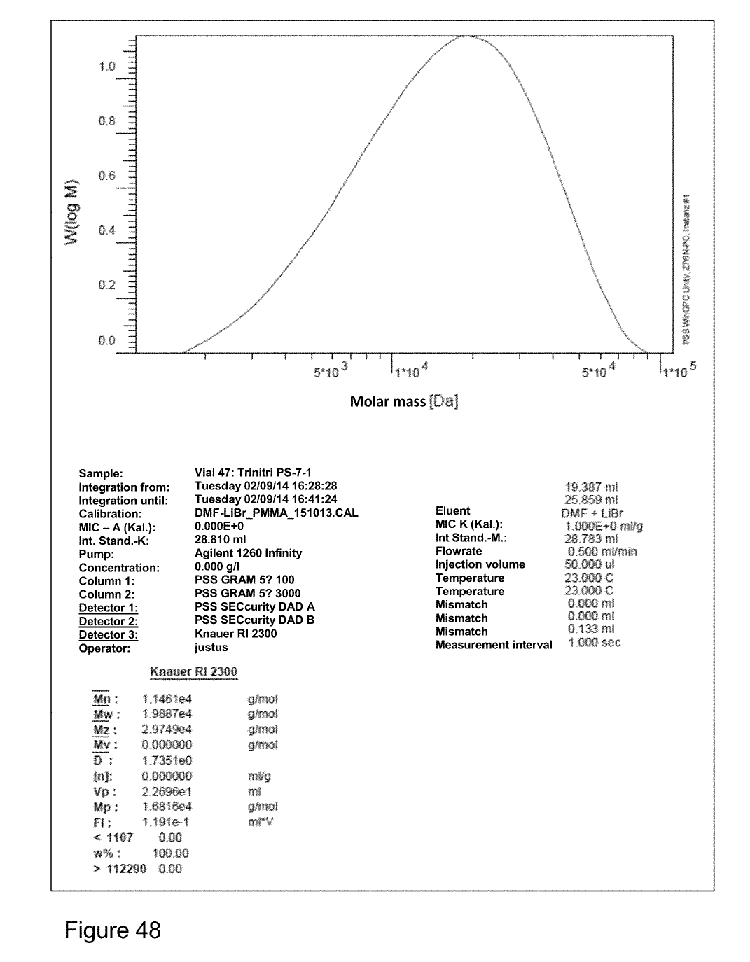

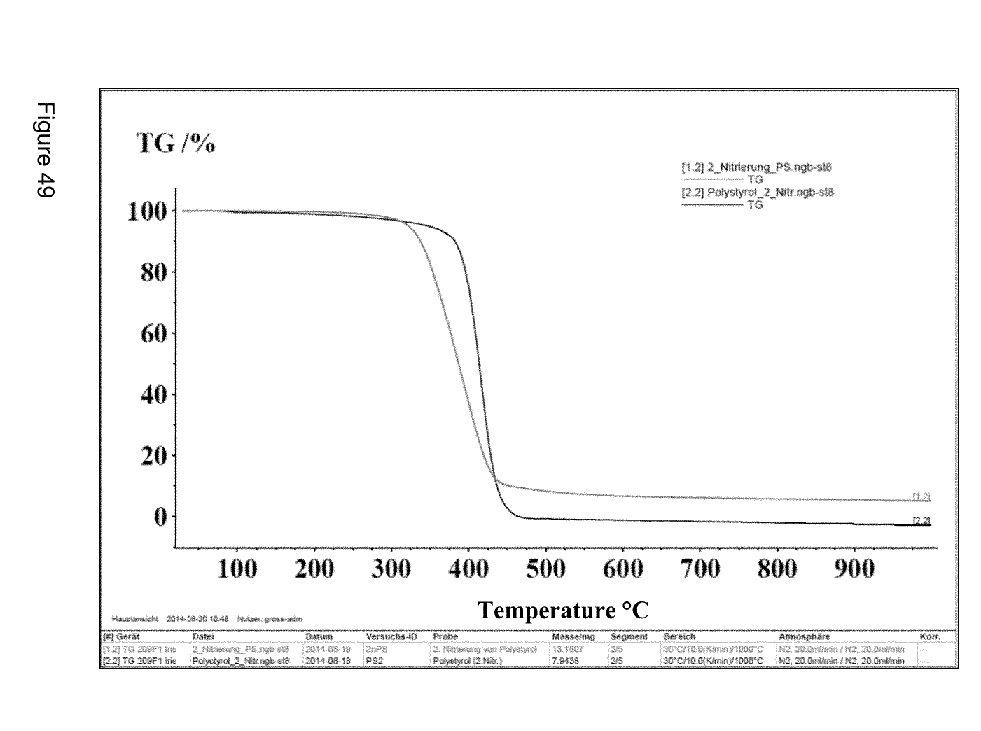

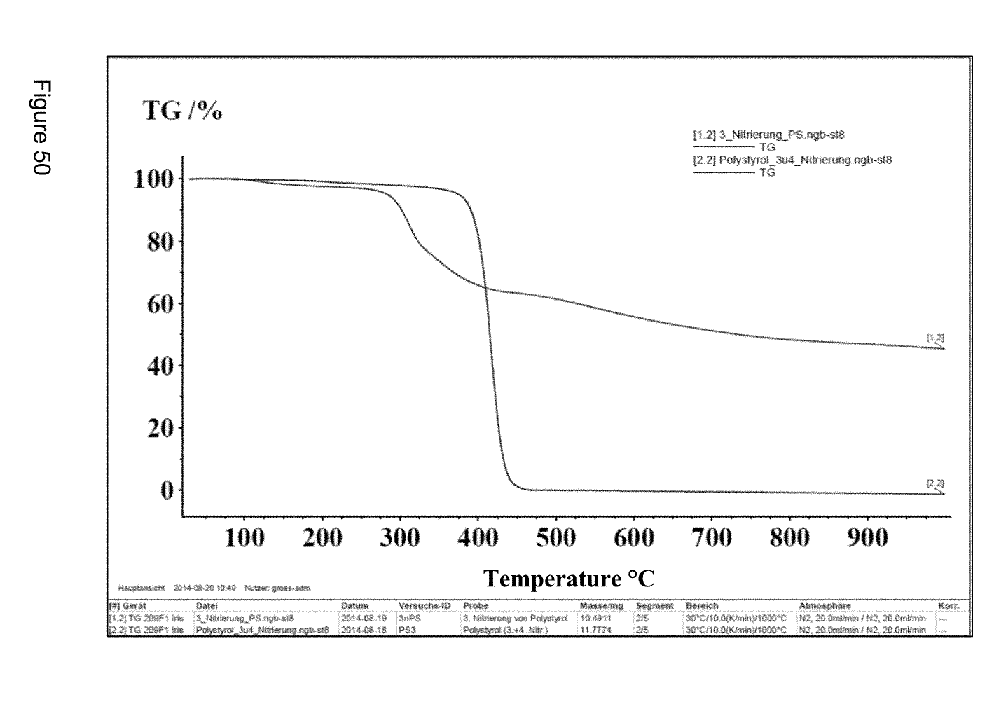

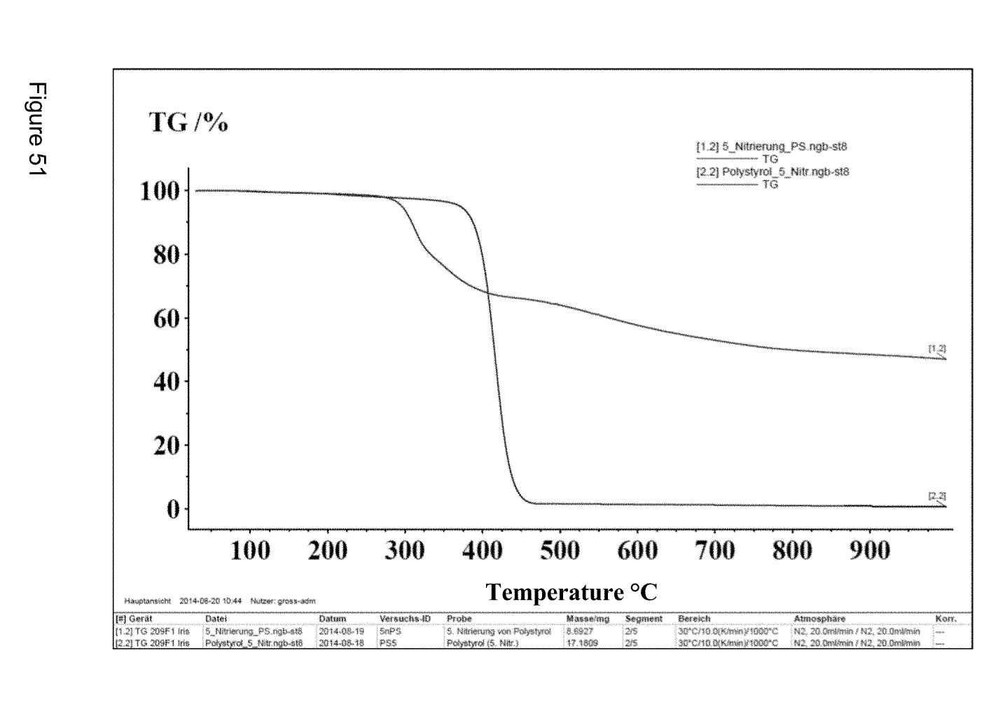

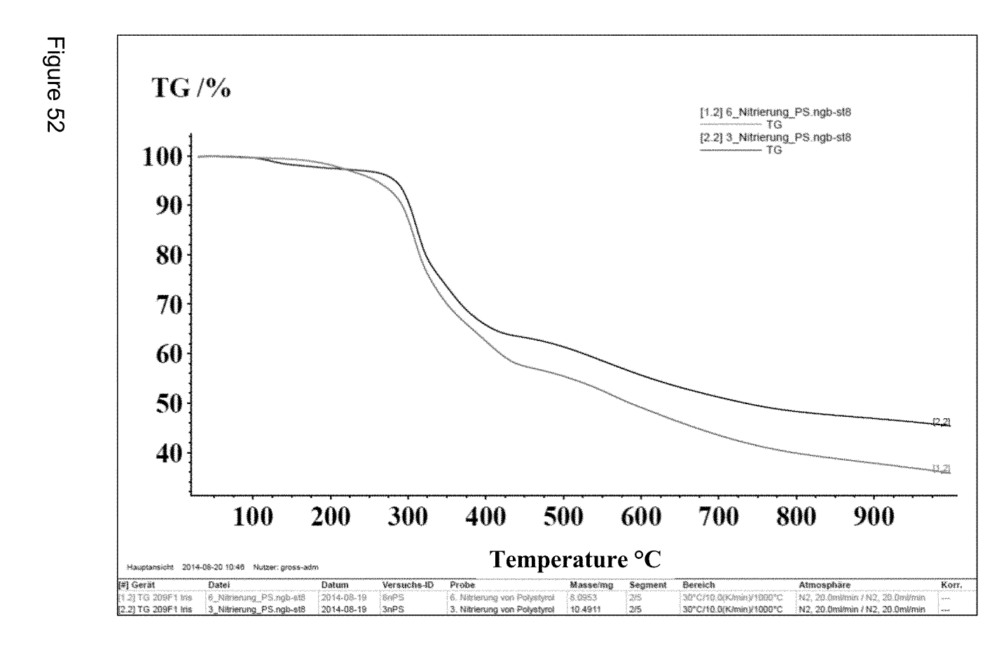

In the next step, measurements were carried out by means of gel permeation chromatography (GPC). DMF was used as solvent. The individual measurements are shown in FIGS. 42 to 48. The summary of the results is contained in Table 15 (M_{nwgemessen})

TABLE 15
Degree of nitration of the nitrated polystyrenes calculated using the molecular weights

| | Substance | Mₙ_{_{w}}_{measured} [g*mol⁻¹] | Mₙ_{_{w}}_{calculated} [g*mol⁻¹] | Degree of nitration |
|---|---|---|---|---|
| Mononitration | Polystyrene (educt) | 6522 | — | 20.4% (Once) |
| | mononitrated polystyrene | 7097 | 9340 | — |
| Dinitration | Polystyrene (educt) | 11901 | — | 100% (Once) |
| | dinitrated polystyrene (in | 18025 | 22186 | 19.09% (Twice) |
| | 1,2-dichloroethane) | | | |
| Trinitration | Polystyrene (educt 1) | 12548 | — | — |
| | dinitrated polystyrene (in | 20976 | 23392 | 100% (Once) |
| | chloroform, educt 2) | | | 55.45% (Twice) |
| | trinitrated polystyrene | 11461 | 28814 | — |

The molecular weight increased in the samples of mononitration and dinitration. This can be traced back to the nitro groups that were incorporated. However, the molecular weight of the reaction product of trinitration decreased in comparison with the dinitrated polystyrene sample used, which leads us to conclude a breakdown of the polymer chains. However, intensive nitro bands can be ascertained in the FT-IR spectrum (see FIG. 41). In order to determine the degree of nitration of the reaction products from the nitration processes, firstly the molecular weights of the nitrated polystyrenes with complete nitration are calculated. The calculation for this is shown in section 3.4. The results (M_{nwberechnen}) are listed in Table 15.

As the molecular weight of the trinitrated polystyrene decreased, the degree of nitration thereof could not be calculated via the molecular weight. This was determined by means of the elemental analysis (see section 2.4.4). It can already be concluded from Table 15 that no complete mononitration and dinitration of the polystyrene took place.

2.4.4

Elemental Analysis

A very much more precise method for determining the degree of nitration is the elemental analysis. The results of these measurements are summarised in the following table.

TABLE 16
Measured and calculated results of the elemental analysis of the reaction
products of the different nitration processes of polystyrene

| | C[%] meas. | calc. | H[%] meas. | calc. | N[%] meas. | calc. | O[%] meas. | calc. |
|---|---|---|---|---|---|---|---|---|
| Mononitration | 86.9 | 64.4 | 7.1 | 4.7 | 1.7 | 9.4 | 4.3 | 21.5 |
| Dinitration in chloroform | 57.4 | 49.5 | 4.1 | 3.1 | 11.3 | 14.4 | 27.2 | 33.0 |
| Dinitration in 1,2-dichloroethane | 59.1 | 49.5 | 4.2 | 3.1 | 10.9 | 14.4 | 25.7 | 33.0 |
| Trinitration | 47.0 | 40.2 | 3.0 | 2.1 | 13.5 | 17.6 | 36.1 | 40.1 |

The above table shows that no complete mononitration, dinitration and trinitration of polystyrene took place. The results of the elemental analyses lead us to conclude the following degrees of nitration of the reaction products:
Mononitration: 13.3% nitrated.
Dinitration in chloroform: 131.2% nitrated→31.2% dinitrated.
Dinitration in 1,2-dichloroethane: 124.9% nitrated→24.9% dinitrated.
Trinitration: 176.9% nitrated→76.9% dinitrated.

The mononitration of polystyrene was not successful. Only 13.3% of the styrene groups could be nitrated. By using a stronger acid, the degree of nitration should increase. This is already shown in the reaction products of dinitration. However, a completely dinitrated polystyrene could not be produced in the dinitration processes of polystyrene either. This could be due to the poor temperature control during the nitration (see section 1.3.2). The reaction product of the trinitration does indeed have the highest degree of nitration, but a trinitrated polystyrene could not be produced. In addition, a polymer chain breakdown took place in this reaction (see section 2.4.3).

2.4.5

Thermal Behaviour

Samples from the different nitration processes were heated in the glow tube up to the point of redness, or red heat. The mononitrated and dinitrated polystyrene disintegrated completely normally, with smoke thereby being produced. The trinitrated sample showed slight tendencies towards an exothermic reaction. A deflagration or even explosive disintegration was not observed in any of the cases.

In addition to the studies mentioned above, thermograms of the samples from the different nitration processes were produced. For comparison purposes, the polystyrene samples used were also analysed. The samples were heated with nitrogen thereby flowing (20 mL/min), in each case 10 K/min, up to a temperature of 1000° C. These thermograms that were produced can be seen in FIGS. 49 to 52. The nitrated samples behave similarly to pure polystyrene when heated.

2.5

Sedimentation Behaviour of Carbon Nanotubes 2.5.1

Low-Molecular Electron-Deficient Compounds

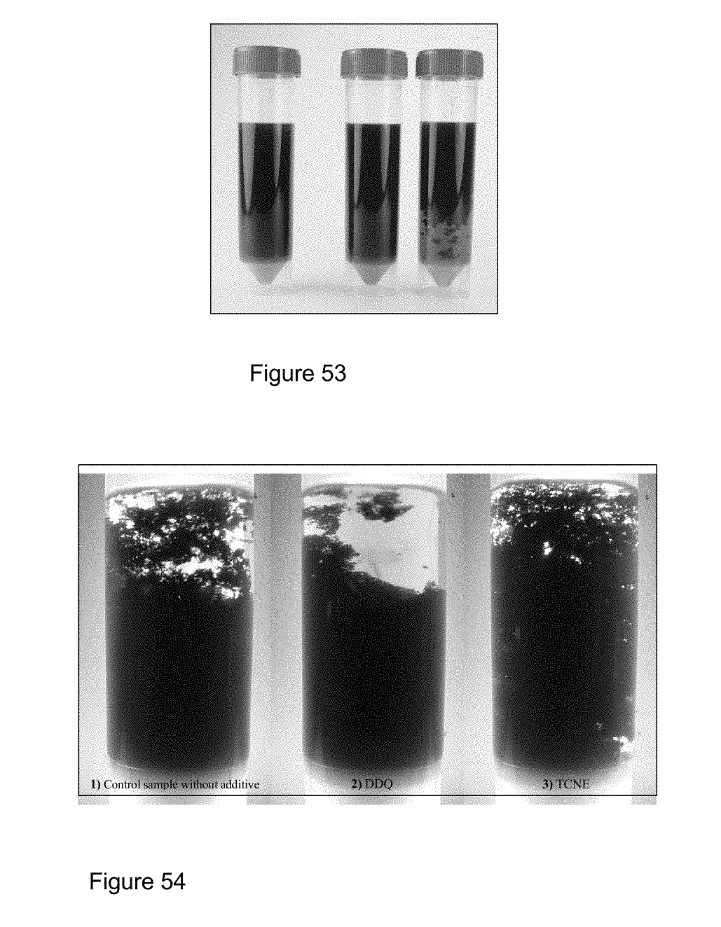

In FIG. 53, the reference sample and the sample with DDQ and TCNE are shown after the dispersion by means of a sonotrode. Large agglomerates can already be seen in sample 3. The other two samples also show significant agglomerate formation by means of transmitted light irradiation.

After three days of storage, this agglomerate formation can be seen more clearly. Further images of these samples can be seen in FIG. 54. These images clearly show that low-molecular electron-deficient compounds are not sufficient for a functionalisation of the CNTs. This is also reflected in the low formation constants (see section 2.3).

2.5.2

High-Molecular Electron-Deficient Compounds

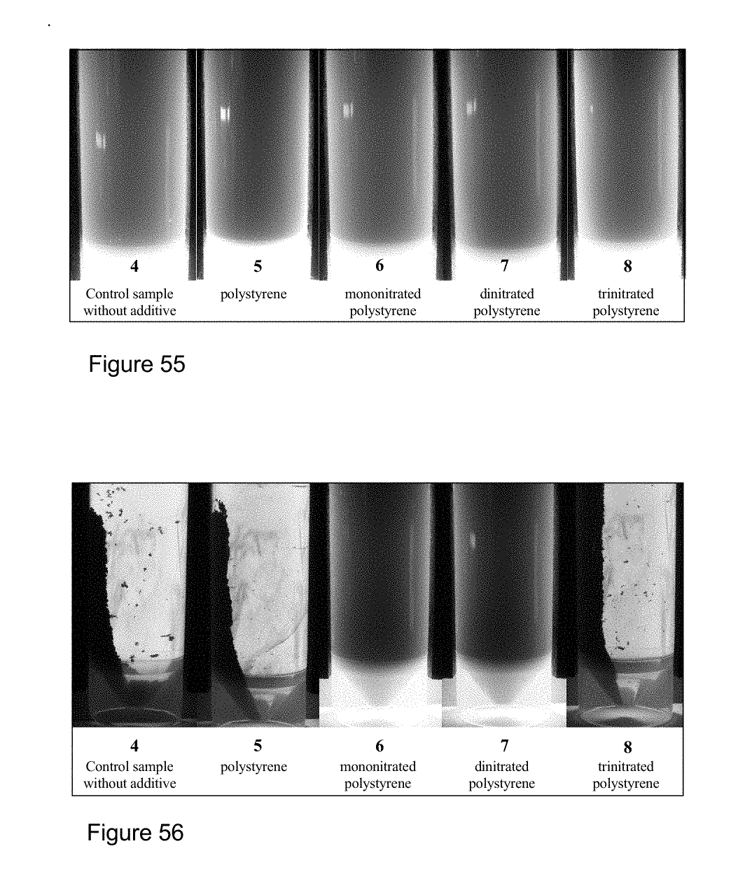

FIG. 55 shows images of the different samples of CNTs and polystyrene and nitrated polystyrenes in DMF directly after dispersion by means of a sonotrode. The images show that the CNTs have dispersed very well in all samples. No agglomerates can be seen.

After centrifugation of these solutions, however, the situation is completely different (see FIG. 56). In the case of samples 4 (CNTs in DMF), 5 (polystyrene) and 8 (trinitrated polystyrene), settled CNTs can be seen on the centrifuge tube walls. When the samples are irradiated, or illuminated, with spiral daylight lamps (see section 3.1.4), the liquids appear lighter in colour. In the mononitrated and dinitrated polystyrene (samples 6 and 7), the CNTs themselves remain suspended after long, high-level centrifugation (3 hours, approximately 6700 g). The dispersion of the carbon nanotubes is very greatly improved by these two additives.

2.5.3

Determination of the Masses of Dispersed CNTs

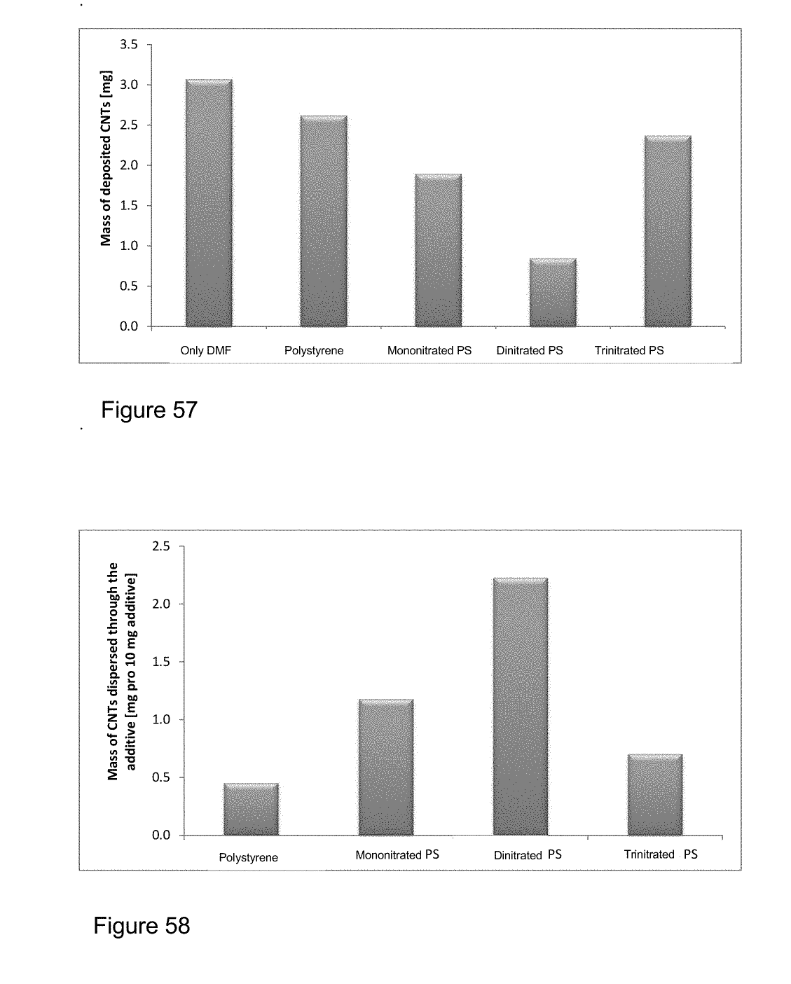

It is not only the photographic documentation of the sedimentation behaviour alone that shows an improvement in the dispersion through mononitrated and dinitrated polystyrene. The weight determination of the sample containers also makes this clear. FIG. 57 shows that, through the reaction products of the mononitration and dinitration of polystyrene, more CNTs can be dispersed in the solvent DMF. The basic calculation for this is indicated in section 3.6.

Wth the aid of this study, the quantity of CNTs that can be additionally dispersed in DMF through the use of 10 mg of the additive can be determined. These results are summarised in FIG. 58. FIG. 58 shows that 2.2 mg of CNTs can be dispersed through 10 mg of the reaction product of the dinitration. The reaction product of the trinitration also shows an improvement in dispersibility, although a polymer chain breakdown took place. These results show that electron-deficient polymers such as for example polynitrostyrene have a very great potential for the development of effective additives for CNT polymer composites. 3.

Materials and Methods

3.1

Materials and Laboratory Equipment Used 3.1.1

Donors

3.1.1.1

Condensed Aromatics

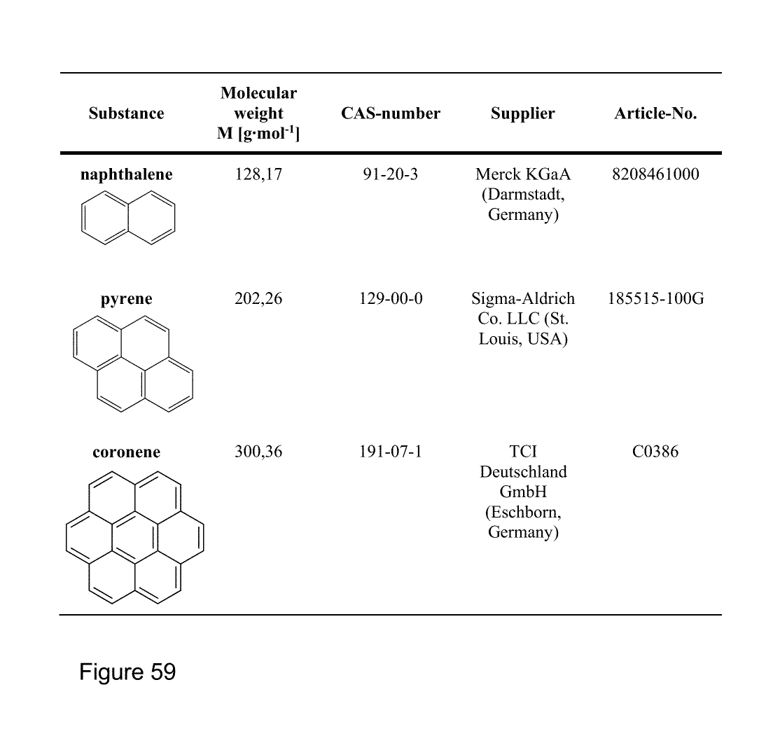

FIG. 59 indicates the electron donors that were used.

3.1.1.2

Carbon Nanotubes

In order to study the influence of electron-deficient compounds in terms of the sedimentation behaviour of carbon nanotubes, the MWCNTs “Nanocyl”™ NC7000” of Nanocyl (company head office in Auvelais, Belgium) were used. These CNTs were produced through catalytic chemical vapour deposition (CCVD). The properties of these CNTs are shown in the following table [18].

TABLE 17
Properties of “Nanocyl ™ NC7000” [18]

| | | | Measurement |
|---|---|---|---|
| Property | Value | Unit | method |
| Purity | 90 | % | TGA |
| Metal oxides | 10 | % | TGA |
| Average diameter | 9.5 | Nm | TEM |
| Average length | 1.5 | μ | TEM |
| Specific surface | 250-300 | M² · g⁻¹ | BET |

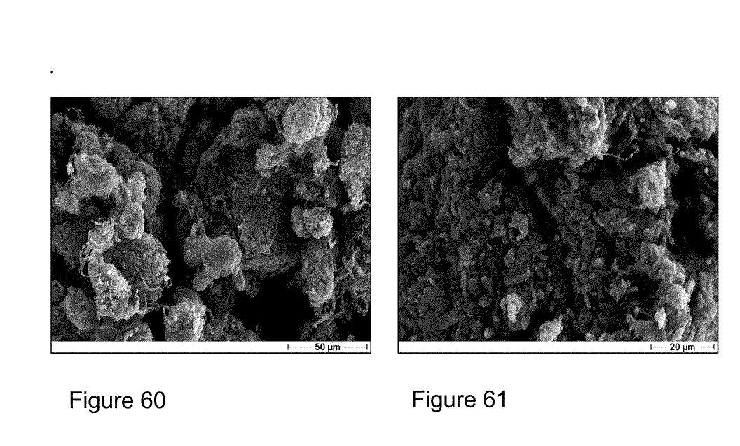

Images of these CNTs were produced by means of a scanning electron microscope (see section 3.1.4). These can be seen in FIG. 60 and FIG. 61. A significant agglomerate formation of the CNTs can be seen in these figures.

3.1.2

Acceptors

3.1.2.1

Low-Molecular Electron-Deficient Compounds

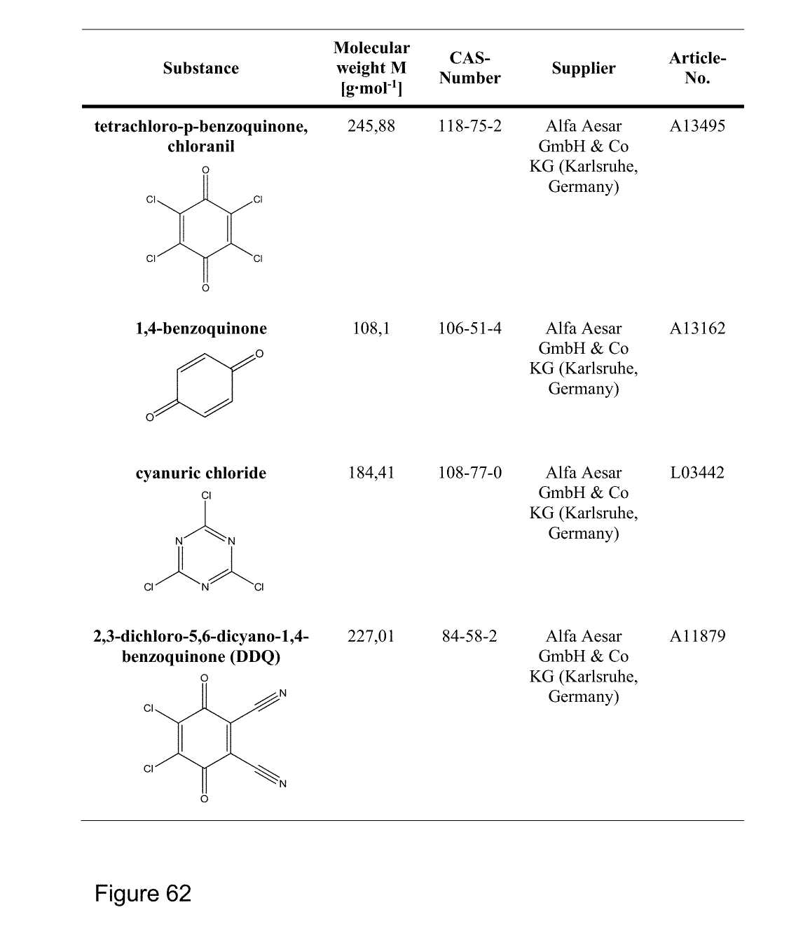

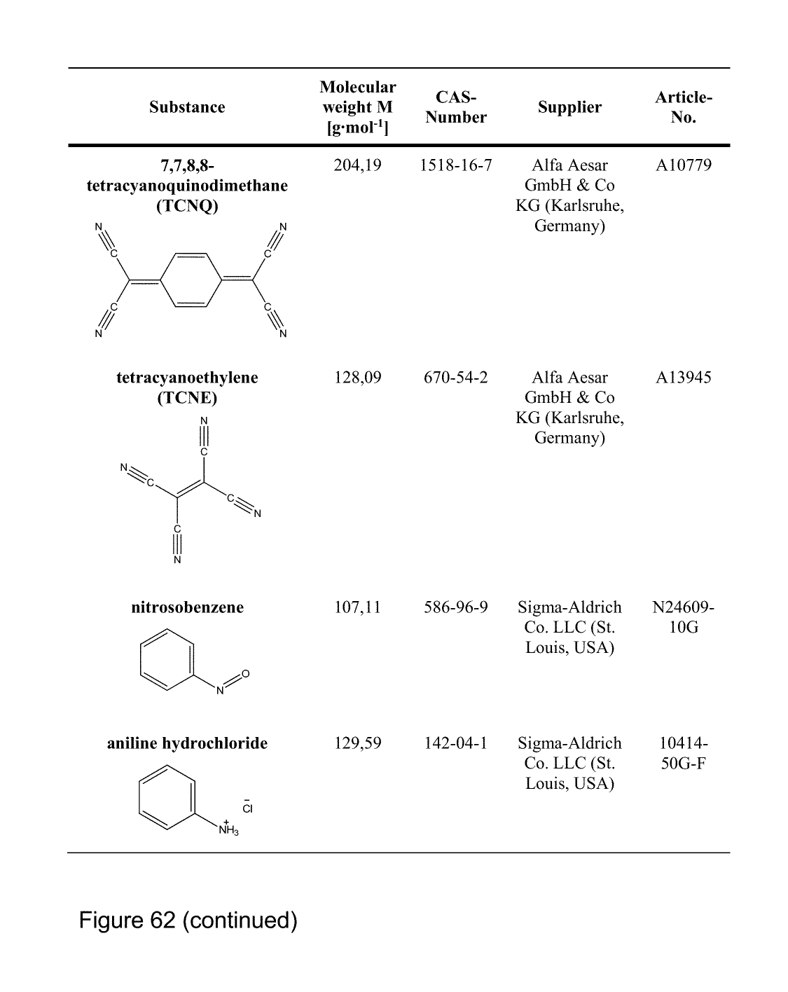

FIG. 62 shows the electron acceptors that were used. The substances nitrosobenzene and aniline hydrochloride were specially selected using the Hammett parameters.

3.1.2.2

High-Molecular Electron-Deficient Compounds

Nitrated polystyrene was used as high-molecular electron-deficient compound. Studies of mononitration, dinitration and trinitration of polystyrene were carried out in this work process. The pure polystyrene used was produced in-house [19].

Polystyrene samples were used within the scope of the following experiments:
Amorphous polystyrene (for mononitration and dinitration in chloroform)
Amorphous and crystalline polystyrene (for dinitration in 1,2-dichloroethane)

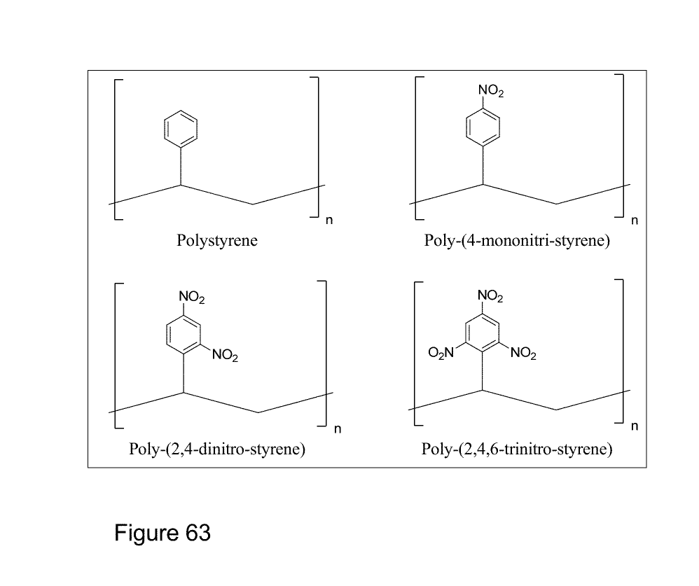

The molecular weight of these samples is indicated in section 2.4.3. FIG. 63 shows the structural formulae of polystyrene and mononitrated, dinitrated and trinitrated polystyrene. A possible substitution form is shown for each of the nitrated polystyrenes.

3.1.3

Further Chemicals

TABLE 18
Chemicals used

| Name | Properties | CAS No. | Supplier | Article No. |
|---|---|---|---|---|
| Chloroform | ≥99%: | 67-66-3 | Carl Roth GmbH & Co. | Y015.2 |
| | synthesis | | KG (Karlsruhe, Germany) | |
| 2-proponal | ≥99.5%: | 67-63-0 | Carl Roth GmbH & Co. | 9866.1 |
| | synthesis | | KG (Karlsruhle, Germany) | |
| 1,2-dichloroethane | ≥99%: | 107-06-2 | Carl Roth GmbH & Co. | T869.2 |
| | synthesis | | KG (Karlsruhle, Germany) | |
| N,N-dimethyl- | ≥99.5%: | 68-12-2 | Carl Roth GmbH & Co. | 6251.1 |
| formamide (DMF) | synthesis | | KG (Karlsruhle, Germany) | |
| Sulphuric acid | Approximately | 7664-93-9 | Acros Organics, Tiel der | 124640011 |
| | 96% | | Fischer Scientific GmbH | |
| | | | (Nidderau Germany) | |
| Nitric acid | 100% | 7697-37-2 | Merck KGaA (Darmstadt, | 100455 |
| | | | Germany) | |
| Nitronium tetra | 96% | 13826-86-3 | Alfa Aesar GmbH & Co | B20167 |
| fluoroborate | | | KG (Karlsruhe, Germany) | |

3.1.4

Laboratory Equipment and Chemical Additives Used

Analytical Balance

The samples were each weighed with the analytical balance Sartorius BA 110 S of Sartorius (Göttingen, Germany). This balance has a maximum capacity of 110 g and a readability of 0.1 mg.

Argon Inert Gas

Argon 6.0 of Westfalen AG (Münster, Germany) was used. The degree of purity of argon is 99.9999 vol.%. The secondary components are nitrogen (<0.0001 vol.%), oxygen (<0.00005 vol. %), water and hydrocarbons (<0.00001 vol.%). In addition this gas was passed through a gas purification cartridge.

Gas Purification Cartridge

The small cartridge ALPHAGAZ Purifier O₂-Free, produced by Air Liquide (Paris, France) was used. Wth this cartridge, oxygen (maximum purity <5 ppb) and humidity (maximum purity <30 ppb) can be removed from the gas.

FT-IR Spectrometer

The IR spectra were recorded on a Nicolet 6700 FT-IR spectrometer, produced by Thermo Scientific (Waltham, USA).

Magnetic Stirrer

The magnetic stirrer RCT Basic of IKA (Staufen, Germany) was used. The heating temperature range is between 25° C. and 310° C. with a heat output of 600 W. The speed range is between 0 and 1500 rpm.

Molecular Sieve

The molecular sieve 4A, Type 514 in pearl form of Carl Roth (Karlsruhe, Germany) was used (Article No.: 8471.2).

Scanning Electron Microscope

For imaging the CNTs, the scanning electronic microscope LEITZ AMR-1000 was used. The magnification range is from 10:1 to 100,000: 1.

Spiral Daylight Lamp

To illuminate the samples, a spiral daylight lamp of Walimex was used. This has nominal or measured power consumption of 125 W. The colour temperature is 5400 K and the colour reproduction index is Ra 82-85. The spiral daylight lamp was located in the lamp shade Helios BIGLAMP 501 Mega matt, produced by B.I.G. Brenner Import and Groβhandels GmbH (Weiden). The aluminium reflector has a diameter of 30 cm.

Sputtering

To produce the REM images of the CNTs, the samples were treated with the SC7620 mini sputter coater of Quorum Technologies. The sputtering was carried out for 90 seconds in argon atmosphere with a current of 18 mA. A gold-palladium target was used in the sputter.

Mirror Reflex ameraC

The photographs shown were taken by means of the digital mirror reflex camera Olympus E-5 of Olympus (Shinjuku, Japan). The Olympus Zuiko Digital ED 12-60 mm, F2.8-4.0 SWD) was used as a lens.

Temperature Measurement Device

The temperature was measured during the nitration processes by means of a VOLTCRAFT K101 temperature measurement device, from Voltcraft (Wollerau, Germany). This can indicate temperatures from −200 to +1370° C. A thermal element PT100 was used as the temperature sensor.

Thermo Microbalance

The thermograms were produced on the thermo microbalance TG 209 F1 Libra® of NETZSCH (Selb, Germany).

Ultrasonic Processor

For the dispersion of the CNTs the ultrasonic processor UP400S (400 Watt, 24 kHz) of Hielscher Ultrasonics (Teltow, Germany) was used. The titanium sonotrode has a diameter of 22 mm.

UVNis Spectrometer

The UV/Vis spectra were recorded on a Varian Cary 100 scan UV/Vis spectrophotometer of VARIAN (Santa Clara, USA) at 25° C. For the measurements, 3 mL quartz cuvettes with a width of 10 mm were used. In addition, the Finnpipette® F3 of Thermo Scientific was used to fill the quartz cuvettes. By means of this pipette, volumes of 100 to 1000 μl can be transferred.

Vacuum Pump System

The vacuum pump system PC 2004 VARIO of Vacuubrand (Wertheim, Germany) was used. An ultimate vacuum, or maximum vacuum, of up to 2 mbar can be reached with a maximum suction capacity of 3.8 m³/h.

Vacuum Drying Cabinet

The samples were dried in the vacuum drying cabinet APT.line™ BD (E2) of Binder (Tuttlingen, Germany).

Centrifuge

The Beckman J2-21 centrifuge of Beckman Coulter (Brea, Calif.) was used. It has a power of 5000 W. The kinetic energy is 175300 Nm. For the centrifugation, the rotor JA-14 was used. Up to 50400 g can be achieved.

3.2 Hammett Parameters

The following table shows the Hammett parameters of a few selected substituents, which were determined by Corwin Hansch. They are set out according to the magnitude of the mesomeric effect.

TABLE 19
Hammett parameters of different substituents [20]

| No. | Substituent | σₘ | σₚ | σₘ − σₚ (≈±M) |
|---|---|---|---|---|
| 31 | NO | 0.62 | 0.91 | −0.29 |
| 325 | CH═C(CN)₂ | 0.66 | 0.84 | −0.18 |
| 84 | CN | 0.56 | 0.66 | −0.10 |
| 64 | COCl | 0.51 | 0.61 | −0.10 |
| 118 | COOH | 0.37 | 0.45 | −0.08 |
| 127 | COHN₂ | 0.28 | 0.36 | −0.08 |
| 32 | NO₂ | 0.71 | 0.78 | −0.07 |
| 117 | CHO | 0.35 | 0.42 | −0.07 |
| 66 | CCl₃ | 0.4 | 0.46 | −0.06 |
| 175 | C≡CH | 0.21 | 0.23 | −0.02 |
| 189 | CH₂CN | 0.16 | 0.18 | −0.02 |
| 101 | CHCl₂ | 0.31 | 0.32 | −0.01 |
| 120 | CH₂Cl | 0.11 | 0.12 | −0.01 |
| 43 | H | 0 | 0 | 0.00 |
| 193 | CH═CH₂ | 0.06 | 0.04 | 0.10 |
| 5 | Cl | 0.37 | 0.23 | 0.14 |
| 2 | Br | 0.39 | 0.23 | 0.16 |
| 28 | I | 0.35 | 0.18 | 0.17 |
| 58 | NH₃⁺ | 0.86 | 0.6 | 0.26 |
| 15 | F | 0.34 | 0.06 | 0.28 |
| 45 | OH | 0.12 | −0.37 | 0.49 |
| 51 | NH₂ | −0.16 | −0.66 | 0.50 |

In this table, NH₃⁺ has a positive mesomeric effect (M=0.26). However, it cannot be followed that this substituent is supposed to have a +M effect. In order to examine this substituent, aniline hydrochloride was used as an electron-deficient compound in the series of experiments carried out. In the experiment (see section 2.1), no 7-interaction of the aniline hydrochloride whatsoever could be ascertained.

3.3

Diagrams for Determining the Formation Constants and Extinction Coefficients of Charge Transfer Complexes

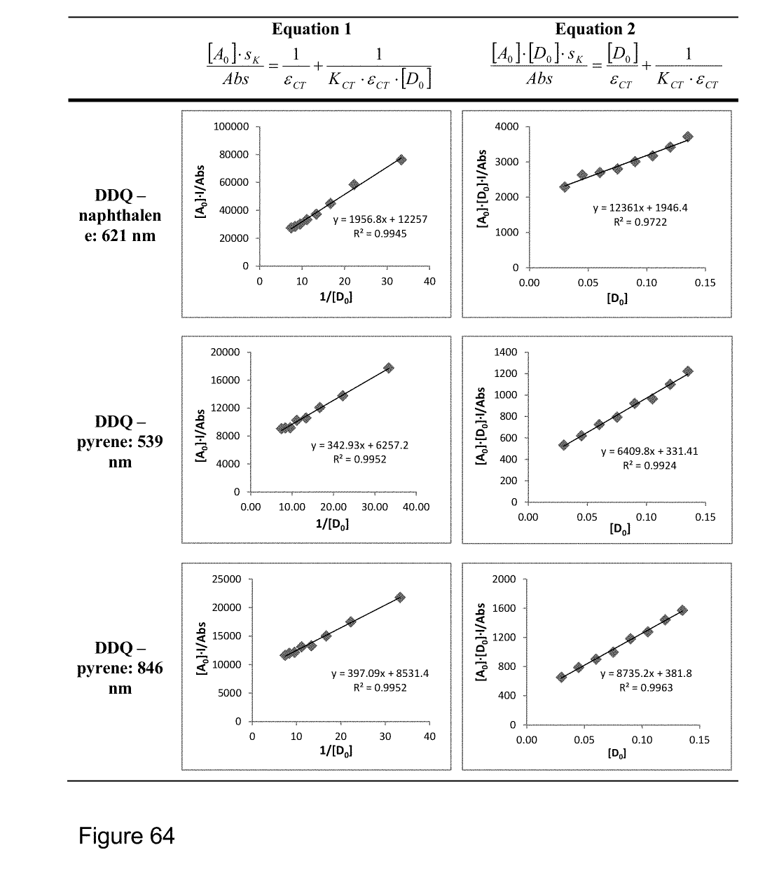

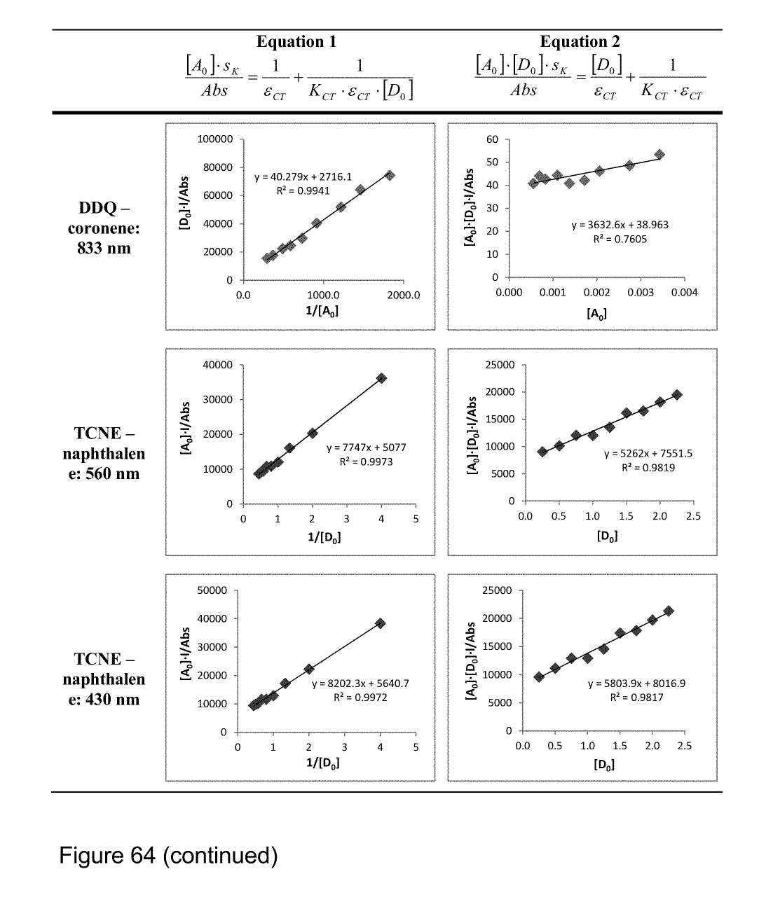

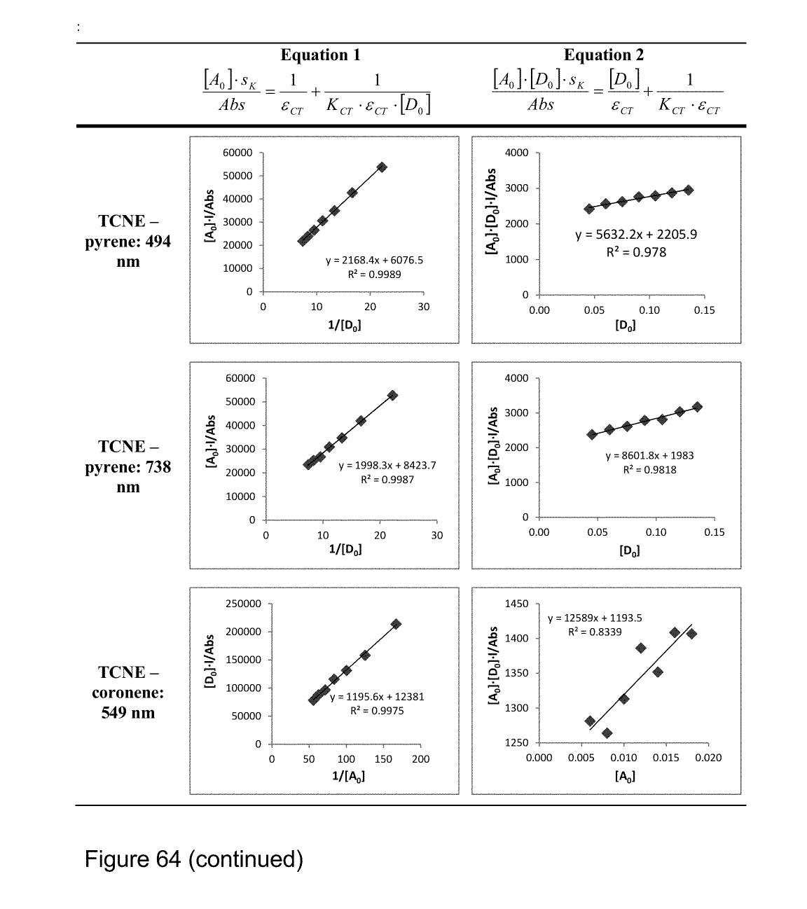

FIG. 64 shows the diagrams that were formulated to calculate the formation constants and extinction coefficients of the charge transfer complexes.

3.4

Calculation of the Molecular Weight and the Degree of Nitration of the Nitrated Polystyrenes

The following calculations are based on the assumption that there was no polymer chain breakdown in the nitration processes. The degree of polymerisation is thus maintained after nitration.

3.4.1

Molecular Weight

The degree of polymerisation P of the polystyrene (PS) used and the molecular weight of the nitrated polystyrenes are calculated as follows.

$$P = \frac{{M}_{ps}}{{M}_{Styrol}}$$

$${M}_{monon \cdot PS} = {M}_{ps} - P \cdot {M}_{\frac{1}{2} {H}_{2}} + P \cdot {M}_{{NO}_{2}}$$

$${M}_{din \cdot PS} = {M}_{ps} - P \cdot 2 \cdot {M}_{\frac{1}{2} {H}_{2}} + P \cdot 2 \cdot {M}_{{NO}_{2}}$$

$${M}_{trin \cdot PS} = {M}_{ps} - P \cdot 3 \cdot {M}_{\frac{1}{2} {H}_{2}} + P \cdot 3 \cdot {M}_{{NO}_{2}}$$

The necessary molecular weights are summarised in Table 20.

TABLE 20
Molecular weight of styrene, hydrogen and a nitro group

| | Styrene | Hydrogen | Nitro group |
|---|---|---|---|
| Molecular weight M [g · mol⁻¹] | 104.15 | 1.008 | 46.010 |

3.4.2

Degree of Nitration of the Mononitration

In order to calculate the degree of nitration, the number (AZ) of nitrated styrene groups must be known. By means of the following equations and the molecular weights determined by the GPC measurement, the number of nitrated styrene groups is calculated as follows.

$${AZ}_{mononStyGr} = \frac{{M}_{monon \cdot PSexp} - {M}_{PS}}{{M}_{{NO}_{2}} = {M}_{\frac{1}{2} {H}_{2}}}$$

Finally, using these values, the degree of nitration (NG) can be calculated.

$${NG}_{Monon \cdot } = \frac{{AZ}_{mononStyGr}}{P}$$

3.4.3

Degree of Nitration of the Dinitration

The calculation of the degree of nitration of the dinitration is based on the assumption that all styrene groups are initially completely mononitrated. The following equation thus applies for the molecular weight of the nitro groups added through dinitration:

M_{zugNO}_{₂}_{-Gr}=M_{dinPS exp}−M_{mononP}

The number of additional nitro groups can now be determined.

$${AZ}_{{zusNO}_{2} - Gr} = \frac{{M}_{{zugNO}_{2} - Gr}}{{M}_{{NO}_{2}} = {M}_{\frac{1}{2} {H}_{2}}}$$

The degree of nitration is thus:

$${NG}_{Din} = \frac{{AZ}_{{zusNO}_{2} - Gr}}{P}$$

The degree of nitration of the trinitration process cannot be calculated with the values of the GPC measurement, as the molecular weight of polystyrene decreased after nitration.

3.5

G—Number Calculation

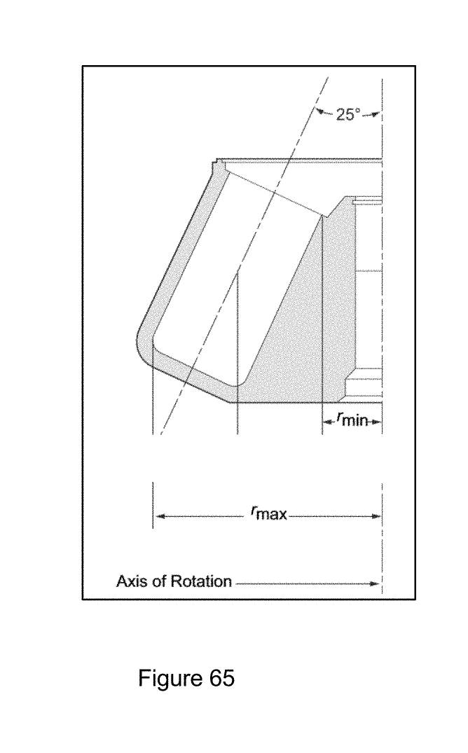

For centrifugation, the rotor JA-14 of Beckman Coulter was used. Six 250 mL centrifuge containers can be placed in this rotor. FIG. 65 shows the geometry of this rotor. The radii (rₘₐₓ, r . . . , rₘᵢₙ) are indicated for 250 mL centrifuge tubes (see Table 21).

Since adapter inserts were used for the studies in this work, 50 mL centrifuge containers could be used. For this reason, the radii rₘₐₓ and rₘᵢₙ indicated in FIG. 65 must be corrected by the wall thickness of these inserts (15 mm). The corrected values are shown in the following Table 21.

TABLE 21
Indicated and corrected values for the radii
of the rotor JA-14 of Beckman Coulter [21]

| | rₘₐₓ[mm] | rₐᵥ[mm] | rₘᵢₙ[mm] |
|---|---|---|---|
| Indicated values | 137 | 86 | 35 |
| Corrected values | 122 | 86 | 50 |

By means of the following equations, the relative centripetal accelerations a_{z} for the corrected radii from Table 21 were calculated as a multiple of the earth acceleration g:

$${a}_{z} = \frac{r \cdot {ω}^{2}}{g} with ω = 2 \cdot π \cdot {n}_{D}$$

In these equations, n_{D} corresponds to the speed and w to the angular velocity. At a speed of 7000 r/min, the following centripetal accelerations are calculated for the corrected radii indicated in Table 22:

TABLE 22
Centripetal acceleration as a multiple
of g at a rotor speed of 7000 r/min

| a_{z}_{ₘₐₓ} · 9.81 | a_{z}_{ₐᵥ} · 9.81 | a_{z}_{ₘᵢₙ} · 9.81 |
|---|---|---|
| m · s⁻² | m · s⁻² | m · s⁻² |
| 6683 | 4711 | 2739 |

3.6

Calculation of the Masses of the Dispersed CNTs

After drying for 24 hours at 90° C., firstly the empty weight of the sample containers mₗₑₑᵣ is determined. After filling the centrifuge tubes with the CNTs, the additives and DMF, the samples are sonicated and then the CNTs dispersed in DMF are removed with a pipette. It is not possible to remove all the liquid in this way, as otherwise non-dispersed CNTs are also removed. The quantity of liquid left over is defined as Vᵣₑₛₜ.

The sample containers are then vacuum-dried at 90° C. for three days and then weighed (m_{trocken}). This allows the following mass change (m_{diff}) to be determined.

m_{diff}=m_{trocken}−mₗₑₑᵣ

Due to the fact that 10 mg of additive is dissolved in 40 mL of DMF in all the samples, the concentration in these samples is constant (c=0.25 mg/mL). The weight of the additive can thus be determined.

m_{additiv}=c·Vᵣₑₛₜ

In order to take into consideration the influence of the sample containers on the weight change, empty centrifuge tubes (control samples) are initially dried in the furnace for 24 hours at 90° C. and then weighed. An average weight loss of mᵥₑᵣₗ=2.7 mg can thereby be determined.

Wth these values, the mass of non-dispersed and dispersed CNTs can be determined.

m_{nichtdisp}=m_{diff}−m_{Additiv}+m_{Verl}

m_{disp}=10 mg−m_{nichtdisp}

By subtracting the quantity of CNTs dispersed in the reference sample 4 (only DMF), the mass of the CNTs dispersed through the additive is finally calculated.

m_{dispAdditiv}=m_{disp}−m_{dispDMF}

The following table summarises the measured and calculated data.

TABLE 23
Weight determination of the centrifuge tubes

| Sample No. | 4 | 5 | 6 | 7 | 8 |
|---|---|---|---|---|---|
| Weight of empty centrifuge tubes mₗₑₑᵣ [g] | 10.4595 | 10.4542 | 10.4515 | 10.4477 | 10.4461 |
| Weight of centrifuge tubes after | 10.4599 | 10.4549 | 10.4511 | 10.4462 | 10.4473 |
| sonication and drying m_{trocken} [g] | | | | | |
| Difference m_{diff} [mg] | 0.4 | 0.7 | −0.4 | −1.5 | 1.2 |
| Remaining volume Vᵣₑₛₜ [ML] | 6 | 3 | 1.5 | 1.3 | 6 |
| Mass of additive in centrifuge tubes m_{Additiv} [mg] | — | 0.8 | 0.4 | 0.3 | 1.5 |
| Difference without additive and with | 3.1 | 2.6 | 1.9 | 0.8 | 2.4 |
| additional consideration of the control | | | | | |
| samples m_{nichtdisp} [mg] | | | | | |
| Dispersed CNTs m_{disp} [mg per 10 mg additive] | 6.9 | 7.4 | 8.1 | 9.2 | 7.6 |
| CNTs dispersed through the additive | — | 0.4 | 1.2 | 2.2 | 0.7 |
| m_{dispAdditiv} [mg per 10 mg additive] | | | | | |

4.

Electron-Deficient Copolymers

4.1

Electron-Deficient Block Copolymers

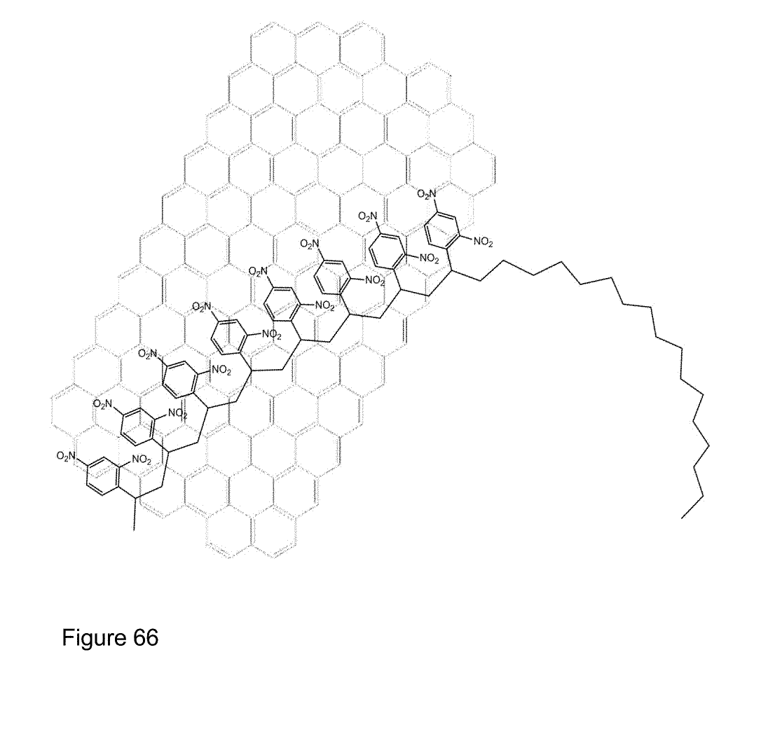

FIG. 66 shows by way of example an electron-deficient polymer according to the invention. The polymer is a block copolymer with an electron-deficient block, which is a dinitro polystyrene in the example (the repeat units are the electron-deficient compounds dinitrostyrene) and a further block, which is a polyethylene in the example. While the dinitro polystyrene block, due to the π-interaction, is affine for the carbon nanomaterial, a carbon nanotube in the example, the further block is affine for the polymer, in which the carbon nanomaterial is to be dispersed.

4.2

Example of the Gain of an Electron-Deficient Polymer

4.2.1

Synthesis of a Poly-(Styrene-Co-Isoprene)

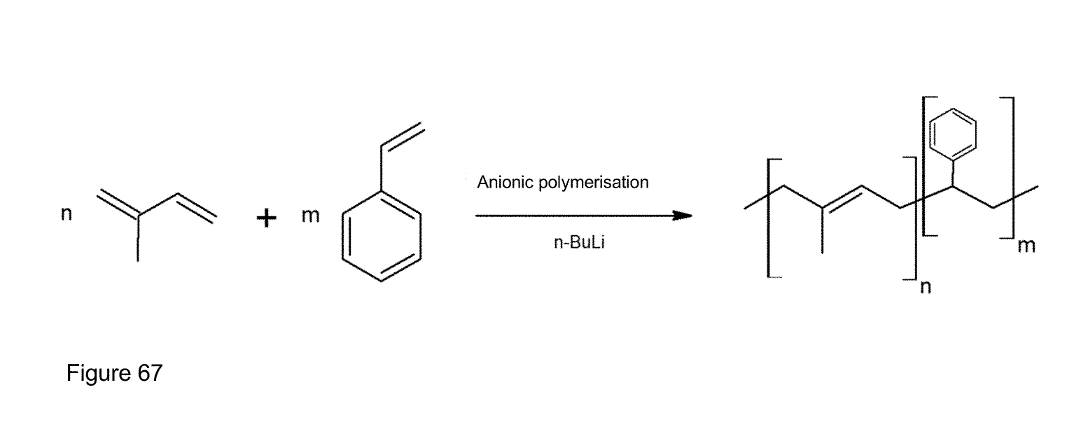

The synthesis of the poly-(styrene-co-isoprene) block copolymer was carried out, as shown in FIG. 67, by means of an anionic polymerisation at room temperature. For this, a Schlenk flask (100 mL) dried overnight at 120° C. was sealed with a septum and was baked out with a hot air blower, with the tap open. After being cooled, the flask was flooded with argon via the septum using a balloon and a cannula. This was carried out with the tap open over a time period of 15 minutes. In order to prevent air from entering the flask, the argon balloon was only removed during the reaction, in order to be refilled. The addition of the solvent, the initiator and the educts was realised only with spray-injecting via the septum with the tap open. During the reaction, the tap was closed.

50 mL of cyclohexane (pre-dried and freshly distilled) was transferred to the oxygen-free and water-free reaction container as a solvent. n-BuLi (1.6 M in cyclohexane) was carefully added in drops until there was a slight yellow colouring, which no longer disappeared after 10 minutes of stirring. A further 100 μL (0.16 mmol) of n-BuLi was then added. After 15 minutes of stirring, 13.32 mL (9.06 g=133 mmol) of isoprene (pre-dried and freshly distilled) was spray-injected into the flask. The reaction mixture was stirred for 24 hours, whereby the yellow colouring became more intense during the first 2 hours.

On the following day, 4.52 mL (4.10 g=39.5 mmol) of styrene (pre-dried and freshly distilled) was added, after which a light orange colour arose, which turned to red over time. After 17 hours of stirring, the reaction was terminated with a small quantity of methanol. The colouring of the reaction mixture thereby disappeared.

The solution was precipitated via a glass rod into 500 mL of ice-cooled methanol, in which 0.26 g of 2,6-Di-tert.-butyl-p-cresol had been dissolved. The white solid obtained had a resin-like consistency. For purification, the polymer obtained, after vacuum filtering, was washed three times, on each occasion with 50 mL of cold methanol and was dried for 2 days in a vacuum furnace at 40° C. The product was 11.62 g of a whitish polymer. This corresponds to a yield of 88.3%.

4.2.2

Hydrogenation of the Poly-(Styrene-Co-Isoprene)

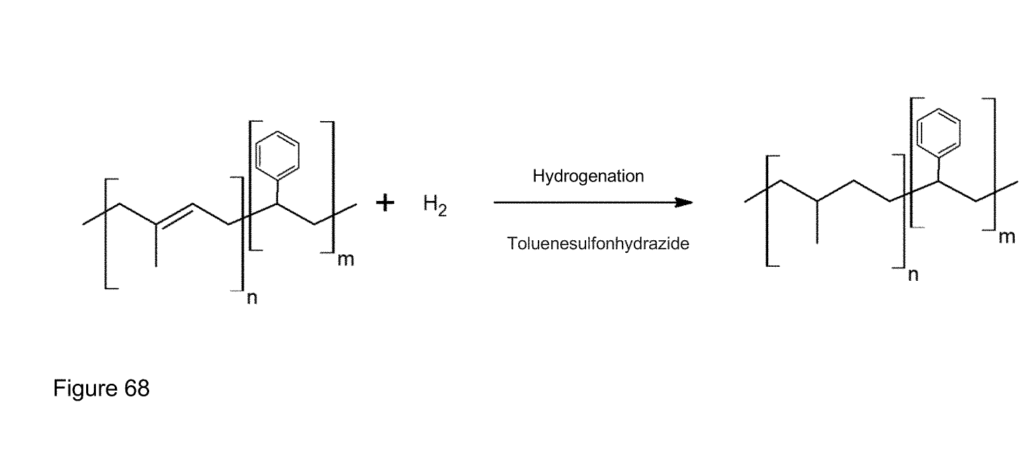

For the hydrogenation, as shown in FIG. 68, 320 mL of a xylene-isomeric mixture was transferred to a 500 mL three-neck flask, and 6.25 g of the poly-(styrene-co-isoprene) block copolymer was dissolved therein with stirring. This quantity contains a number of approximately 63 mmol double bond equivalents. Nitrogen was added to the reaction mixture during the reaction via a glass tube. In addition, there was a reflux condenser on the flask. After heating to 135° C., through an oil bath, 23.44 g (126 mmol) of p-toluene sulfonyl hydrazide was added via a powder funnel and the apparatus was sealed. The mixture was then stirred for 17 hours.

The solution, which was still hot, was slowly precipitated into 700 mL of ice-cooled methanol via a glass rod. After vacuum filtering, the polymer was washed twice with 100 mL of hot water and dried overnight at 50° C. in a vacuum furnace. The product was 5.37 g of a transparent polymer. This corresponds to a yield of 84.3%.

4.2.3

Nitration of the Poly-(Styrene-Co-2-Methylbutylene) Block Copolymer

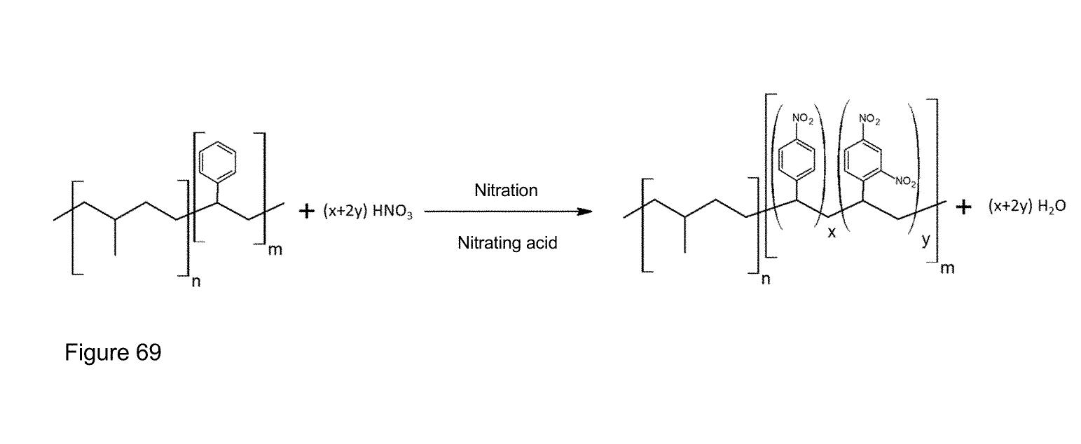

In the nitration shown in FIG. 69, a reflux condenser with a drying tube, and also a temperature sensor were arranged on a 100 mL three-neck flask. 50 mL of chloroform was added to the flask, in which 1.77 g of the copolymer was dissolved with stirring over a time period of one hour. For cooling, there was a cold mixture of calcium chloride and ice in a ratio of 1:1. In a beaker in the ice bath, nitration acid was prepared from 5 mL of nitric acid (w>99%) and 7 mL of sulphuric acid (w=96%). After the chloroform-polymer solution had been cooled down to −10° C., the nitration acid was carefully added in drops via a dropping funnel with pressure balance, so that the temperature did not exceed 0° C. Then, stirring was carried out for 3 hours at room temperature. A brown-yellow discolouration arose. After some time, a yellowish solid could be seen, which settled.

The reaction solution was carefully precipitated, thereby forming white smoke, into 200 mL of ice-cold isopropanol. A yellow solid was formed, which was vacuum filtered and washed twice with 50 mL of cold isopropanol. For further purification, the solid was dissolved in 100 mL of DMF, the solution was filtered and then precipitated, i.e. “fall out” into 500 mL of water. After vacuum filtering, washing was carried out four times with 100 mL of water and 2 times with 50 mL of isopropanol. The product was 1.74 g of a yellow powder. This corresponds to a yield of 79.6% under the assumption that a complete dinitration is present. The features disclosed in the above description, the claims and the drawings can be significant both individually and also in any combination for the realisation of the invention in its different embodiments.

### LITERATURE

[1] M. Hara et al., “Formation and decay of pyrene radical cation and pyrene dimer radical cation in the absence and presence of cyclodextrins during resonant two-photon ionization of pyrene and sodium 1-pyrene sulfonate,” Physical Chemistry Chemical Physics, pp. 3215-3220, 2004.
[2] A. Kira et al., “Spectroscopic Study on Aggregate Ion Radicals of Naphthalene and Pyrene in γ-Irradiated Alkane Glasses,” The Journal of Physical Chemistry, pp. 1445-b 1448, 1976.
[3] J. T. Richards et al., “Formation of Ions and Excited States in the Laser Photolysis of Solutions of Pyrene,” The Journal of Physical Chemistry, pp. 4137-4141, 1970.
[4] A. Liu et al., “Transient absorption spectra of aromatic radical cations in hydrocarbon solutions,” Journal of Photochemistry and Photobiology A: Chemistry, pp. 197-208, 1992.
[5] W. Berger et al, “Elektrophile und nukleophile Substitution an Aromaten—Nitrierung,” in Organikum, Johann Ambrosius Barth Verlag, 1996, pp. 340-343.
[6] G. A. Olah und H. C. Lin, “Synthetic Methods and Reactions; Xl. A Convenient Direct Preparation of 1,3,5-Trinitrobenzene from m-Dinitrobenzene by Nitration with Nitronium Tetrafluoroborate in Fluorosulfuric Acid,” Synthesis, pp. 444-445, Juni 1974.
[7] I. Ostromisslensky, “Über eine neue, auf dem Massenwirkungsgesetz fuβende Analysenmethode einiger binären (sic!) Verbindungen,” Berichte der deutschen chemischen Gesellschaft, pp. 268-273, 1911.
[8] P. Job, “Formation and stability of inorganic complexes in solution,” Annales de chimie, pp. 113-203, 1928.
[9] J. S. Renny et al., “Method of Continuous Variations: Applications of Job Plots to the

Study of Molecular Associations on Organometallic Chemistry,” Angewandte Chemie International Edition, pp. 2-18, 2013.
[10] W. Likussar und D. F. Boltz, “Theory of Continuous Variations Plots,” Analytical Chemistry, pp. 1265-1272, 10 Aug. 1971.
[11] H. Benesi und J. Hildebrand, “A Spectrophotometric Investigation of the Interaction of Iodine with Aromatic Hydrocarbons,” Journal of The American Chemical Society, pp. 2703-2707, 1949.
[12] R. L. Scott, “Some Comments on the Benesi-Hildebrand—Equation,” Recueil des Travaux Chimiques des Pays-Bas, pp. 787-789, 1956.
[13] A.-G. E L-Kourashy, “Intermolecular charge-transfer studies on p-tolylthiourea-iodine system,” Spectrochimica Acta, pp. 399-403, 1981.
[14] R. Abu-Eittah und F. Al-Sugeir, “Charge-transfer interaction of bithienyls and some thiophene derivatives with electron acceptors,” Canadian Journal of Chemistry, pp. 3705-3712, 1976.
[15] A. Mostafa und H. S. Bazzi, “Synthesis and spectroscopic studies on charge—transfer molecular complexes formed in the reaction of imidazole and 1-benzylimidazole with σ- and π-acceptors,” Spectrochimica Acta Part A, pp. 1613-1620, 2011.
[16] G. Wehnert, persönliche Mitteilung, T H Nürnberg, 2014.
[17] M. D. Fernandez, M. J. Fernandez und I. J. McEwen, “Blends of poly(styrene-ran-2,4-dinitrostyrene with poly(vinyl methyl ether) and poly(2,6-dimethyl-1,4-phenylene oxide),” Polymer, pp. 2767-2772, 1997.
[18] N. S.A., “Nanocyl—The Carbon Nanotube Specialist,” 10 März 2009. [Online]. Available: http://www.nanocyl.com/en/Products-Solutions/Products/Nanocyl-NC-7000-Thin-Multiwall-Carbon-Nanotubes. [Zugriff am 18 Sep. 2014].
[19] 0. Repp, Untersuchungen zur Polymerisation von Styrol, Diplomarbeit, TH Nürnberg, 2012.
[20] C. Hansch, A. LEO und R. W. Taft, “A Survey of Hammett Substituent Constants and Resonance and Field Parameters,” Chemical Reviews, pp. 165-195, 1991.
[21] Beckman Coulter, Beckman Coulter JA-14 Fixed Angle Rotor Manual, 2014.

1. Dispersion of a carbon nanomaterial in a dispersion medium, wherein the dispersion medium contains an electron-deficient compound.

2. Dispersion according to claim 1, wherein the electron-deficient compound has an electron-deficient aromatic.

3. Dispersion according to claim 1, wherein the dispersion medium comprises a polymer.

4. Dispersion according to claim 3, wherein the polymer is different from the electron-deficient compound.

5. Dispersion according to claim 1, wherein the electron-deficient compound is an electron-deficient polymer.

6. Dispersion according to claim 5, wherein the electron-deficient polymer is a copolymer.

7. Dispersion according to claim 5, wherein the electron-deficient polymer is a block copolymer.

8. Dispersion according to claim 5, wherein the dispersion medium has, besides the electron-deficient polymer, a further polymer.

9. Dispersion according to claim 1, wherein the carbon nanomaterial comprises carbon nanotubes.

10. Use of an electron-deficient compound in a dispersion medium to modify the dispersion behaviour of carbon nanomaterial in the dispersion medium.

11. Use according to claim 10, wherein the dispersion medium comprises a polymer that is different from the electron-deficient compound.

12. Method for producing a polymer-containing substance, wherein a dispersion according to claim 1 is mixed with a polymer.

13. Method according to claim 12, wherein a polymer is contained in the dispersion and this polymer is the same as the polymer with which the dispersion is mixed.

14. Method according to claim 12, wherein the polymer, with which the dispersion is mixed, is different from the electron-deficient compound of the dispersion.

15. Dispersion according to claim 6, wherein the electron-deficient polymer is a block copolymer.

16. Dispersion according claim 6, wherein the dispersion medium has, besides the electron-deficient polymer, a further polymer.

17. Method according to claim 13, wherein the polymer, with which the dispersion is mixed, is different from the electron-deficient compound of the dispersion.
